(19) United States
(12) Patent Application Publication
(10) Pub. No.: US 2013/0023618 A1
(43) Pub. Date: Jan. 24, 2013

(54) PROFILE EXTRUSION MOLDING RESIN COMPOSITION AND PROFILE EXTRUSION RESIN MOLDED PRODUCT

(71) Applicants: Shinichi Miyake, Tokyo (JP); Tadashi Nagahara, Tokyo (JP)

(72) Inventors: Shinichi Miyake, Tokyo (JP); Tadashi Nagahara, Tokyo (JP)

(21) Appl. No.: 13/574,668

(22) PCT Filed: Jan. 24, 2011
(86) PCT No.: PCT/JP2011/051242

§ 371 Date: Sep. 18, 2012

(30) Foreign Application Priority Data
Jan. 25, 2010 (JP) 2010-012871
Jan. 25, 2010 (JP) 2010-012872

(51) Int. Cl. C08L 51/00; C08K 3/34; C08K 5/01; C08L 51/06; C08L 55/02

(52) U.S. Cl. 524/456; 524/504

(57) ABSTRACT

The present invention provides a profile extrusion molding resin composition capable of forming a profile extrusion resin molded product which is excellent in strength, impact resistance, heat resistance, scratch resistance, surface appearance and shaping property. The profile extrusion molding resin composition of the present invention comprises an aromatic vinyl-based resin component which comprises a rubber-reinforced aromatic vinyl-based resin (A) having the following definition (1) and an ultrahigh molecular weight aromatic vinyl-based resin (B) having the following definition (2) at specific proportions, said resin composition further comprising a lubricant (C) and an inorganic filler (D) in specific amounts based on the aromatic vinyl-based resin component: (1) A resin which is constituted from a graft polymer (a1) obtained by graft-polymerizing an aromatic vinyl compound in the presence of a rubber polymer and, if required, a polymer (a2) obtained by polymerizing an aromatic vinyl compound (with the proviso that a content of the component (a2) is not more than 90% by mass based on a total amount of the components (a1) and (a2)), and which has an acetone-soluble component having a weight-average molecular weight of not more than 1,000,000; and (2) a resin which is obtained by polymerizing a monomer component comprising an aromatic vinyl compound, and which has an acetone-soluble component having a weight-average molecular weight of not less than 2,000,000.

### TECHNICAL FIELD

The present invention relates to a profile extrusion molding resin composition and a profile extrusion resin molded product.

### BACKGROUND ART

Hitherto, profile extrusion molded products having a complicated sectional shape have been extensively used in various application fields such as civil engineering, building industries, furniture and mechanical parts. As resins for the profile extrusion molded products, there have been used those resins such as vinyl chloride-based resins, styrene-based resins, polyolefin-based resins and polyester-based resins, which resins are excellent in moldability and product properties such as rigidity and dimension stability. In the profile extrusion molding process, there has been used the method in which the resin is plasticized in an extruder and formed into a desired shape in a die fitted at a tip end of the extruder, and then the thus molded resin is cooled and solidified by sequentially passing it through a sizing plate, a sizing die and a cooling zone such as a water bath to thereby obtain a profile extrusion resin molded product.

There is known the profile extrusion resin molded product produced from a rubber-modified styrene-based resin composition comprising a rubber-modified styrene-based resin including a continuous phase constituted from a polymer obtained by introducing an acrylic acid ester (or methacrylic acid ester)-based monomer such as methyl methacrylate into a styrene-based monomer and a dispersed phase constituted from a rubber elastomer whose particle diameter is optimized, and a terpene-based resin, and it is described that the profile extrusion resin molded product is excellent in transparency, strength, appearance properties, printing properties or the like (refer to Patent Document 1). In addition, there is also known the profile extrusion resin molded product produced from a resin composition comprising a rubber-modified thermoplastic resin obtained by graft-polymerizing an aromatic vinyl compound and a (meth)acrylic acid ester to a rubber polymer constituted from a styrene-butadiene block copolymer having a specific structure as a main component, and it is described that the profile extrusion resin molded product has a high strength, a high surface hardness and a high cutting property, and is excellent in transparency and appearance (refer to Patent Document 2).

On the other hand, it is known that a resin molded product having excellent surface properties and a high foaming rate can be readily produced from a styrene-based resin composition comprising a styrene-based resin comprising an acetone-soluble component having a weight-average molecular weight of not more than 1,000,000, a thermoplastic resin having a weight-average molecular weight of not less than 3,000,000, a thermoplastic resin having a weight-average molecular weight of not less than 2,000,000 and a glass transition temperature lower by −10° C. or less than that of the above thermoplastic resin, and an olefin-based resin (refer to Patent Document 3).

However, any of the above materials may fail to exhibit fully satisfactory strength and scratch resistance.

### PRIOR DOCUMENTS

### Patent Documents

Patent Document 1: Japanese Patent Application Laid-Open (KOKAI) No. 7-32440 (1995)
Patent Document 2: Japanese Patent Application Laid-Open (KOKAI) No. 2002-172673
Patent Document 3: Japanese Patent Application Laid-Open (KOKAI) No. 2004-323635

### SUMMARY OF THE INVENTION

### Problems to be Solved by the Invention

The present invention has been accomplished to solve the above problems. An object of the present invention is to provide a profile extrusion molding resin composition which exhibits an excellent kneading property upon production thereof, and is capable of producing a profile extrusion resin molded product which is excellent in strength, impact resistance, heat resistance, scratch resistance, surface appearance and shaping property, and a profile extrusion resin molded product produced from the profile extrusion molding resin composition.

### Means for Solving the Problem

That is, in a first aspect of the present invention, there is provided a profile extrusion molding resin composition comprising a resin component which comprises 80 to 99.9% by mass of a rubber-reinforced aromatic vinyl-based resin (A) having the following definition (1) and 0.1 to 20% by mass of an ultrahigh molecular weight aromatic vinyl-based resin (B) having the following definition (2) (with the proviso that a total amount of the component (A) and the component (B) is 100% by mass), said resin composition further comprising a lubricant (C) and an inorganic filler (D) in amounts of 0.1 to 20 parts by mass and 10 to 100 parts by mass, respectively, based on 100 parts by mass of the resin component.

(1) A resin which is constituted from a graft polymer (a1) obtained by graft-polymerizing a monomer component comprising an aromatic vinyl compound in the presence of a rubber polymer and, if required, a polymer (a2) obtained by polymerizing a monomer component comprising an aromatic vinyl compound (with the proviso that a content of the component (a2) is not more than 90% by mass based on a total amount of the components (a1) and (a2)), and which has an acetone-soluble component having a weight-average molecular weight of not more than 1,000,000; and

(2) a resin which is obtained by polymerizing a monomer component comprising an aromatic vinyl compound, and which has an acetone-soluble component having a weight-average molecular weight of not less than 2,000,000.

In a second aspect of the present invention, there is provided a profile extrusion resin molded product obtained from the above profile extrusion molding resin composition.

### Effect of the Invention

In accordance with the present invention, there can be provided a profile extrusion molding resin composition which exhibits an excellent kneading property upon production thereof, and is capable of forming a profile extrusion resin molded product which is excellent in strength, impact resistance, heat resistance, scratch resistance, surface appearance and shaping property, as well as a profile extrusion resin molded product obtained from the profile extrusion molding resin composition. Meanwhile, in the following description, the “profile extrusion molding resin composition” is referred to merely as a “resin composition”.

### PREFERRED EMBODIMENTS FOR CARRYING OUT THE INVENTION

The present invention is described in detail below. Meanwhile, the “(meth)acrylate” as used herein means an acrylate and/or a methacrylate.

The profile extrusion molding resin composition according to the present invention comprises an resin component as a base component which comprises 80 to 99.9% by mass of a rubber-reinforced aromatic vinyl-based resin (A) having the above definition (1) and 0.1 to 20% by mass of an ultrahigh molecular weight aromatic vinyl-based resin (B) having the above definition (2) (with the proviso that a total amount of the component (A) and the component (B) is 100% by mass).

The rubber polymer used in the rubber-reinforced aromatic vinyl-based resin (A) having the above definition (1) is not particularly limited. In the following description, such an embodiment is referred to as an “Embodiment 1”.

In the present invention, as 80 to 99.9% by mass of the rubber-reinforced aromatic vinyl-based resin (A) having the above definition (1), there may be used a resin comprising 60 to 99.8% by mass of a rubber-reinforced aromatic vinyl-based resin (A1) having the following definition (1′) and 0.1 to 20% by mass of an ethylene-α-olefin-based rubber-reinforced aromatic vinyl-based resin (A2) having the following definition (2′). In the following description, such an embodiment is referred to as an “Embodiment 2”. When being used in combination with the ethylene-α-olefin-based rubber polymer as the rubber polymer as defined below, it is possible to obtain a resin composition capable of producing a profile extrusion resin molded product which is excellent especially in kneading property, surface appearance and shaping property.

(1′) A resin which is constituted from the graft polymer (a1) obtained by graft-polymerizing a monomer component comprising an aromatic vinyl compound in the presence of a rubber polymer (except for an ethylene-α-olefin-based rubber) and, if required, the polymer (a2) obtained by polymerizing a monomer component comprising an aromatic vinyl compound (with the proviso that a content of the component (a2) is not more than 90% by mass based on a total amount of the components (a1) and (a2)), and which has an acetone-soluble component having a weight-average molecular weight of not more than 1,000,000; and

(2′) a resin which is constituted from a graft polymer (b1) obtained by graft-polymerizing a monomer component comprising an aromatic vinyl compound in the presence of an ethylene-α-olefin-based rubber and, if required, a polymer (b2) obtained by polymerizing a monomer component comprising an aromatic vinyl compound (with the proviso that a content of the component (b2) is not more than 90% by mass based on a total amount of the components (a1) and (a2)), and which has an acetone-soluble component having a weight-average molecular weight of not more than 1,000,000.

### <Rubber-Reinforced Aromatic Vinyl-Based Resins (A), (A1) and (A2)>

First, the rubber polymer in the graft polymer (a1) of the component (A) used in the Embodiment 1 is explained. Examples of the rubber polymer include diene-based rubbers such as polybutadiene, butadiene-styrene copolymers, butadiene-acrylonitrile copolymers, styrene-butadiene-based block copolymers and hydrogenated products thereof, and styrene-isoprene-based block copolymers and hydrogenated products thereof; acrylic rubbers; silicone-based rubbers; silicone-acrylic IPN rubbers; and ethylene-α-olefin-based rubbers.

Examples of the ethylene-α-olefin-based rubbers include ethylene-α-olefin-based copolymers and ethylene-α-olefin-non-conjugated diene copolymers. Specific examples of the ethylene-α-olefin-based rubbers include ethylene-propylene copolymers, ethylene-propylene-non-conjugated diene copolymers, ethylene-1-butene copolymers and ethylene-1-butene-non-conjugated diene copolymers.

The above polymers may be used in combination of any two or more thereof. Among these polymers, preferred are polybutadiene, butadiene-styrene copolymers, styrene-butadiene block copolymers, and hydrogenated products of the styrene-butadiene block copolymers, acrylic rubbers and ethylene-α-olefin-based rubbers. The resin composition as a final product when using the diene-based rubber polymer therein is excellent in balance between properties thereof. The resin composition as a final product when using the non-diene-based rubber polymer therein is excellent in weather resistance.

Next, the rubber polymer in the graft polymer (a1) of the component (A1) used in the Embodiment 2 is explained. As the rubber polymer, there may be used the above-exemplified rubber polymers except for ethylene-α-olefin-based rubbers. These rubber polymers may be used in combination of any two or more thereof. Among these rubber polymers, preferred are polybutadiene, butadiene-styrene copolymers, styrene-butadiene block copolymers, hydrogenated products of the styrene-butadiene block copolymers and acrylic rubbers. The resin composition as a final product when using an acryl-based rubber polymer and/or a diene-based rubber polymer therein is excellent in balance between properties thereof.

Next, the rubber polymer in the graft polymer (b1) of the component (A2) used in the Embodiment 2 is explained. In this case, as the rubber polymer, there may be used the ethylene-α-olefin-based rubbers. Specific examples of the ethylene-α-olefin-based rubbers are those described above. The ethylene-α-olefin-based rubbers are explained in more detail below.

Examples of the α-olefin include α-olefins having 3 to 20 carbon atoms. Specific examples of the α-olefin include propylene, 1-butene, 1-pentene, 1-hexene, 4-methyl-1-pentene, 1-heptene, 1-octene, 1-decene, 1-dodecene, 1-hexadecene and 1-eicosene. These α-olefins may be used in combination of any two or more thereof. When the number of carbon atoms in the α-olefin is more than 20, such an α-olefin tends to be deteriorated in copolymerizability so that the resulting resin molded product tends to exhibit a poor surface appearance. The number of carbon atoms in the α-olefin is preferably 3 to 12 and more preferably 3 to 8.

The mass ratio of ethylene to α-olefin (ethylene: α-olefin) is usually 5 to 95:95 to 5, preferably 50 to 90:50 to 10 and more preferably 60 to 88:40 to 12. When the mass ratio of the α-olefin is more than 95, the resulting resin composition tends to be deteriorated in weather resistance. When the mass ratio of the α-olefin is less than 5, the resulting resin composition tends to be deteriorated in rubber elasticity.

Examples of the non-conjugated dienes include alkenyl norbornenes, cyclic dienes and aliphatic dienes. Among these non-conjugated dienes, especially preferred are 5-ethylidene-2-norbornene and dicyclopentadiene. These non-conjugated dienes may be used in combination of any two or more thereof.

The proportion of the non-conjugated diene based on a whole amount of the rubber polymer is usually 0 to 30% by mass, preferably 0 to 20% by mass and more preferably 0 to 10% by mass. When the proportion of the non-conjugated diene is more than 30% by mass, the resulting resin molded product tends to be insufficient in appearance and weather resistance.

The Mooney viscosity of the ethylene-α-olefin-based rubber (as measured at ML₁₊₄ (100° C.) according to JIS K6300) is usually 5 to 80, preferably 10 to 65 and more preferably 15 to 45. When the Mooney viscosity of the ethylene-α-olefin-based rubber is more than 80, the resulting rubber-reinforced aromatic vinyl-based resin tends to be deteriorated in fluidity. When the Mooney viscosity of the ethylene-α-olefin-based rubber is less than 5, the resulting rubber-reinforced aromatic vinyl-based resin tends to be deteriorated in impact resistance.

In addition, the ethylene-α-olefin-based rubber may also include hydrogenated products of block (co)polymers obtained from a conjugated diene compound such as butadiene and isoprene. The above polymers may be in the form of either a crosslinked polymer or a non-crosslinked polymer. Meanwhile, the hydrogenation rate of a double bond of a conjugated diene moiety of the ethylene-α-olefin-based rubber is preferably not less than 90% from the standpoint of a good weather resistance.

Next, the above respective rubber-reinforced aromatic vinyl-based resins are explained. Meanwhile, the above monomer component comprising an aromatic vinyl compound will be described later.

The content of the rubber polymer in each of the rubber-reinforced aromatic vinyl-based resins (A) and (A1) is usually 2 to 70% by mass, preferably 3 to 60% by mass and more preferably 4 to 50% by mass. When the content of the rubber polymer falls within the above-specified range, the resin composition as a final aimed product is excellent in balance between properties including impact resistance, moldability and rigidity.

The content of the rubber polymer in the rubber-reinforced aromatic vinyl-based resin (A2) is usually 2 to 40% by mass and preferably 3 to 35% by mass. When the content of the rubber polymer falls within the above-specified range, the resin composition as a final aimed product is excellent in balance between properties including impact resistance, moldability and rigidity.

The weight-average molecular weight of the acetone-soluble component in each of the rubber-reinforced aromatic vinyl-based resins (A), (A1) and (A2) is not more than 1,000,000. The above acetone-soluble component may be obtained as follow. That is, 1 g of the rubber-reinforced aromatic vinyl-based resin (A) is dissolved in 20 mL of acetone (shaken using a shaker for 2 hr), and subjected to centrifugal separation (at a rotating speed of 23,000 rpm) using a centrifugal separator for 60 min to remove the solvent therefrom. The thus obtained acetone-soluble component is subjected to GPC to determine a weight-average molecular weight thereof.

Examples of the monomer component comprising an aromatic vinyl compound used in each of the above graft polymer (a1), the above polymer (a2), the above graft polymer (b1) and the above polymer (b2) include, in addition to the aromatic vinyl compound, cyanided vinyl compounds; (meth)acrylic acid ester compounds; maleimide-based compounds; and vinyl-based compounds comprising a functional group such as an acid anhydride group, a hydroxyl group, an amino group, an epoxy group, a carboxyl group and an oxazoline group.

Examples of the aromatic vinyl compound include styrene, α-methyl styrene and p-methoxy styrene. Among these aromatic vinyl compounds, especially preferred are styrene and α-methyl styrene. These aromatic vinyl compounds may be used in combination with any two or more thereof.

Examples of the cyanided vinyl compounds include acrylonitrile and methacrylonitrile. These cyanided vinyl compounds may be used in combination with any two or more thereof.

Examples of the (meth)acrylic acid ester compounds include methyl (meth)acrylate, ethyl (meth)acrylate and butyl (meth)acrylate. These (meth)acrylic acid ester compounds may be used in combination with any two or more thereof.

Examples of the maleimide-based compounds include maleimide, N-phenyl maleimide and N-cyclohexyl maleimide. These maleimide-based compounds may be used in combination with any two or more thereof. Meanwhile, when introducing a maleimide-based compound unit to the aimed molecule, there may be used the method in which maleic anhydride is first copolymerized with the molecule, and then the copolymerized product may be subjected to imidation reaction.

Examples of the acid anhydrides include maleic anhydride, itaconic anhydride and citraconic anhydride. These compounds may be used in combination of any two or more thereof.

Examples of the hydroxyl group-containing compounds include 3-hydroxy-1-propene, 4-hydroxy-1-butene, cis-4-hydroxy-2-butene, trans-4-hydroxy-2-butene, 3-hydroxy-2-methyl-1-propene, hydroxystyrene, 2-hydroxyethyl (meth)acrylate and N-(4-hydroxyphenyl)maleimide. These hydroxyl group-containing compounds may be used in combination of any two or more thereof.

Examples of the amino group-containing compounds include aminoethyl (meth)acrylate, propylaminoethyl (meth)acrylate, diethylaminoethyl (meth)acrylate, phenylaminoethyl (meth)acrylate, N-vinyl diethyl amine, N-acetyl vinyl amine, (meth)acrylamine, N-methyl acrylamine, (meth)acrylamide, N-methyl acrylamide and p-aminostyrene. These amino group-containing compounds may be used in combination of any two or more thereof.

Examples of the epoxy group-containing compounds include glycidyl (meth)acrylate, 3,4-oxycyclohexyl (meth)acrylate, vinyl glycidyl ether, acryl glycidyl ether and methacrylic glycidyl ether. These epoxy group-containing compounds may be used in combination of any two or more thereof.

Examples of the carboxyl group-containing compounds include (meth)acrylic acid, ethacrylic acid, maleic acid, fumaric acid, itaconic acid, crotonic acid and cinnamic acid. These carboxyl group-containing compounds may be used in combination of any two or more thereof.

Examples of the oxazoline group-containing compounds include vinyl oxazoline and the like. These oxazoline group-containing compounds may be used in combination of any two or more thereof.

The amounts of the respective vinyl-based monomers used in the above rubber-reinforced aromatic vinyl-based resins (A) and (A1) and the above ethylene-α-olefin-based rubber-reinforced aromatic vinyl-based resin (A2) are usually 10 to 100% by mass, preferably 10 to 90% by mass and more preferably 10 to 80% by mass based on 100% by mass of a total amount of the vinyl-based monomers. When the amounts of the vinyl-based monomers fall within the above-specified range, the resin composition as a final aimed product is excellent in balance between properties including moldability and mechanical strength.

The cyanided vinyl compound may be used in an amount of usually not more than 50% by mass and preferably 5 to 40% by mass. When the amount of the cyanided vinyl compound used falls within the above-specified range, the resin composition as a final aimed product is excellent in balance between properties including chemical resistance, color tone and moldability.

The (meth)acrylic acid ester compound may be used in an amount of usually not more than 90% by mass and preferably 10 to 85% by mass based on 100% by mass of a total amount of the vinyl-based monomers. When the amount of the (meth)acrylic acid ester compound used falls within the above-specified range, the resin composition as a final aimed product is excellent in balance between properties including coloring property and moldability.

The maleimide-based compound may be used in an amount of usually not more than 50% by mass and preferably 10 to 50% by mass based on 100% by mass of a total amount of the vinyl-based monomers. When the amount of the maleimide-based compound used falls within the above-specified range, the resin composition as a final aimed product is excellent in balance between properties including heat resistance and moldability.

The functional group-containing vinyl-based compound may be used in an amount of usually not more than 20% by mass and preferably 1 to 15% by mass based on 100% by mass of a total amount of the vinyl-based monomers. When the amount of the functional group-containing vinyl-based compound used falls within the above-specified range, the resin composition as a final aimed product is excellent in balance between compatibility-imparting effect and appearance of a resin molded product obtained therefrom.

The combination of the above monomers may include the following examples (1) to (6).

(1) A monomer component comprising an aromatic vinyl compound and a cyanided vinyl compound.
(2) A monomer component comprising at least two compounds selected from the group consisting of an aromatic vinyl compound, a cyanided vinyl compound, a (meth)acrylic acid ester compound and a maleimide-based compound.
(3) A monomer component comprising an aromatic vinyl compound and a (meth)acrylic acid ester compound.
(4) A monomer component comprising an aromatic vinyl compound and a maleimide-based compound.
(5) A monomer component comprising an aromatic vinyl compound and a functional group-containing vinyl-based compound.
(6) A monomer component comprising at least one compound selected from the group consisting of an aromatic vinyl compound, a cyanided vinyl compound, a (meth)acrylic acid ester compound and a maleimide-based compound, and a functional group-containing vinyl-based compound.

The graft polymer (a1) used in the above rubber-reinforced aromatic vinyl-based resins (A) and (A1) and the graft polymer (b1) used in the above ethylene-α-olefin-based rubber-reinforced aromatic vinyl-based resin (A2) may be produced by known polymerization methods, for example, by emulsion polymerization method, bulk polymerization method, solution polymerization method, suspension polymerization method and combination of these methods. Among these polymerization methods, preferred are emulsion polymerization method, solution polymerization method and suspension polymerization method.

When the graft polymer (a1) and/or the graft polymer (b1) are produced by the emulsion polymerization method, there may be usually used a polymerization initiator, a chain transfer agent, an emulsifier and the like. Examples of the polymerization initiator include cumene hydroperoxide, p-menthane hydroperoxide, diisopropyl benzene hydroperoxide, tetramethylbutyl hydroperoxide, tert-butyl hydroperoxide, potassium persulfate and azobisisobutyronitrile. As the polymerization initiation assistant, there are preferably used redox-based agents such as various reducing agents, sugar-containing iron pyrophosphate compounds and sulfoxylate compounds.

Examples of the chain transfer agents include mercaptans such as octyl mercaptan, n-dodecyl mercaptan, t-dodecyl mercaptan and n-hexyl mercaptan; and terpinolenes. Examples of the emulsifiers include alkylbenzenesulfonic acid salts such as sodium dodecylbenzenesulfonate; aliphatic sulfonic acid salts such as sodium laurylsulfate; higher fatty acid salts such as potassium laurate, potassium stearate, potassium oleate and potassium palmitate; rosinates such as potassium rosinate; and dialkyl sulfo-succinic acid salts such as sodium dioctyl sulfosuccinate.

When the graft polymer (a1) and/or the graft polymer (b1) are produced by the emulsion polymerization method, the rubber polymer and the monomer component may be used in the following manner. That is, a whole amount of the monomer component may be added at one time, or intermittently in divided parts or continuously in the presence of a whole amount of the rubber polymer to polymerize both the components with each other. Alternatively, a part of the rubber polymer may be added in the course of the polymerization.

The rubber polymer may be used in an amount of usually 3 to 80 parts by mass, preferably 5 to 70 parts by mass and more preferably 10 to 60 parts by mass based on 100 parts by mass of the graft polymer.

After completion of the emulsion polymerization, the resulting latex is usually treated with a coagulant to coagulate a resin component thereof, and further washed with water and then dried, thereby obtaining a purified graft polymer. Examples of the coagulant include inorganic salts such as calcium chloride, magnesium sulfate and magnesium chloride; inorganic acids such as sulfuric acid and hydrochloric acid; and organic acids such as acetic acid, citric acid and malic acid. Meanwhile, when two or more kinds of latexes are obtained by the emulsion polymerization, these latexes may be coagulated separately, or may be appropriately blended together and then coagulated.

When the graft polymer (a1) and/or the graft polymer (b1) are produced by the solution polymerization method, the solution polymerization may be usually carried out in a known inert polymerization solvent usually used in radical polymerization. Examples of the solvent include aromatic hydrocarbons such as ethyl benzene and toluene; ketones such as methyl ethyl ketone and acetone; acetonitrile; dimethylformamide; and N-methylpyrrolidone. The polymerization temperature is usually 80 to 140° C. and preferably 85 to 120° C.

The solution polymerization may be carried out using a polymerization initiator, or under heating without using the polymerization initiator. Examples of the polymerization initiator include azo compounds such as azobisisobutyronitrile; and organic peroxides such as ketone peroxides, dialkyl peroxides, diacyl peroxides, peroxyesters, hydroperoxides and benzoyl peroxide. Examples of the chain transfer agent include mercaptans, terpinolenes and α-methyl styrene dimer.

In addition, when the graft polymer (a1) and/or the graft polymer (b1) are produced by the bulk polymerization method or suspension polymerization method, there may be used known polymerization methods as well as the polymerization initiators, chain transfer agents, etc., as described in the above solution polymerization.

The thus produced graft polymer (a1) and/or graft polymer (b1) usually comprise a grafted component formed by graft-(co)polymerizing the monomer component to the rubber polymer, and a non-grafted component comprising no rubber polymer to which the monomer component is grafted (a (co)polymer of the monomer component). The number-average particle size of the grafted component is usually 0.05 to 3 μm, preferably 0.1 to 2 μm and more preferably 0.15 to 1.5 μm. Meanwhile, the number-average particle size may be measured by known methods such as the method using an electron microscope.

The graft percentage of the graft polymer (a1) and the graft polymer (b1) is usually 20 to 200% by mass, preferably 30 to 150% by mass and more preferably 40 to 120% by mass. When the graft percentage of the graft polymer (a1) and the graft polymer (b1) falls within the above-specified range, the resin composition as a final aimed product is excellent in impact resistance. Meanwhile, the graft percentage may be determined by the following method.

When a mass (g) of a rubber polymer contained in 1 g of the graft polymer (a1) or the graft polymer (b1) is represented by S grams; and a mass (g) of an insoluble component obtained by dissolving 1 g of the rubber-reinforced aromatic vinyl-based resin (A) or (A1) or the ethylene-α-olefin-based rubber-reinforced aromatic vinyl-based resin (A2) in 20 mL of acetone (shaking the resin and acetone using a shaker for 2 hr) and then subjecting the resulting solution to centrifugal separation using a centrifugal separator (rotating speed: 23,000 rpm) for 60 min to separate the insoluble component therefrom is represented by T grams, the graft percentage is calculated from the following formula (I).

Graft percentage={(T−S)/S}×100 (1)

The intrinsic viscosity [η] of the acetone-soluble component in the graft polymer (a1) or the graft polymer (b1) (as measured at 30° C. using methyl ethyl ketone as a solvent) is usually 0.2 to 1.2 dL/g, preferably 0.2 to 1.0 dL/g, more preferably 0.3 to 0.8 dL/g and especially preferably 0.3 to 0.7 dL/g. When the intrinsic viscosity [η] of the acetone-soluble component is less than 0.2 dL/g, the resin composition as a final aimed product tends to be deteriorated in impact resistance, whereas when the intrinsic viscosity [η] of the acetone-soluble component is more than 1.2 dL/g, the resulting resin molded product tends to be deteriorated in surface appearance.

Meanwhile, the graft percentage and the intrinsic viscosity [η] can be readily controlled by varying kinds and amounts of the polymerization initiator, the chain transfer agent, the emulsifier and the solvent as well as polymerization time, polymerization temperature, etc., used upon production of the graft polymer (a1) or the graft polymer (b1).

The proportions of the monomer component and the respective components in the polymer (a2) may be the same as those explained with respect to the graft polymer (a1). The proportions of the monomer component and the respective components in the polymer obtained by polymerizing the monomer component comprising the aromatic vinyl compound may be just the same as those of the vinyl-based monomer used for producing the above graft polymer, or may be different therefrom.

The proportions of the monomer component and the respective components in the polymer (b2) may be the same as those explained with respect to the graft polymer (b1). The proportions of the monomer component and the respective components in the polymer obtained by polymerizing the monomer component comprising the aromatic vinyl compound may be just the same as those of the vinyl-based monomer used for producing the above graft polymer, or may be different therefrom.

The polymer (a2) obtained by polymerizing the monomer component comprising the aromatic vinyl compound and the polymer (b2) obtained by polymerizing the monomer component comprising the aromatic vinyl compound may be produced by known polymerization methods, for example, by bulk polymerization method, solution polymerization method, suspension polymerization method and emulsion polymerization method.

The intrinsic viscosity [η] of the acetone-soluble component in the polymer (a2) obtained by polymerizing the monomer component comprising the aromatic vinyl compound and the polymer (b2) obtained by polymerizing the monomer component comprising the aromatic vinyl compound (as measured at 30° C. using methyl ethyl ketone as a solvent) is usually 0.2 to 1.2 dL/g, preferably 0.2 to 1.0 dL/g, more preferably 0.3 to 0.8 dL/g and especially preferably 0.3 to 0.7 dL/g. When the intrinsic viscosity [η] of the acetone-soluble component is less than 0.2 dL/g, the resin composition as a final aimed product tends to be deteriorated in impact resistance, whereas when the intrinsic viscosity [η] of the acetone-soluble component is more than 1.2 dL/g, the resulting resin molded product tends to be deteriorated in surface appearance. Meanwhile, the intrinsic viscosity [η] of the acetone-soluble component in the polymer (a2) or the polymer (b2) can be controlled by varying various production conditions similarly to the case of the above graft polymer (a1) and the above graft polymer (b1).

Specific examples of the rubber-reinforced aromatic vinyl-based resin (A) used in the Embodiment 1 of the present invention include ABS resins, ASA resins and AES resins.

Specific examples of the rubber-reinforced aromatic vinyl-based resin (A1) used in the Embodiment 2 of the present invention include ABS resins and ASA resins. Specific examples of the rubber-reinforced aromatic vinyl-based resin (A2) used in the Embodiment 2 of the present invention include AES resins.

The proportion of the polymer (a2) in the rubber-reinforced aromatic vinyl-based resins (A) and (A1) is not more than 90% by mass and preferably not more than 80% by mass based on a total amount of the graft polymer (a1) and the polymer (a2). When the proportion of the polymer (a2) is more than the above-specified range, the effect attained by using the graft polymer (a1) tends to be lowered. Also, the proportion of the polymer (b2) in the ethylene-α-olefin-based rubber-reinforced aromatic vinyl-based resin (A2) is not more than 90% by mass and preferably not more than 80% by mass based on a total amount of the graft polymer (b1) and the polymer (b2) for the same reasons as described above.

### <Ultrahigh Molecular Weight Aromatic Vinyl-Based Resin (B)>

The ultrahigh molecular weight aromatic vinyl-based resin (B) used in the present invention may be obtained by polymerizing a monomer component comprising an aromatic vinyl compound, and is a resin comprising an acetone-soluble component having a weight-average molecular weight of not less than 2,000,000.

Examples of the monomer component comprising an aromatic vinyl compound which is contained in the ultrahigh molecular weight aromatic vinyl-based resin (B) include, in addition to the aromatic vinyl compounds, cyanided vinyl compounds; (meth)acrylic acid ester compounds; maleimide-based compounds; and vinyl compounds containing a functional group such as a carboxyl group, an acid anhydride group, an epoxy group, a hydroxyl group, an amide group, an amino group and an oxazoline group.

Examples of the aromatic vinyl compound include styrene, t-butyl styrene, α-methyl styrene, p-methyl styrene, divinyl benzene, 1,1-diphenyl styrene, N,N-diethyl-p-aminoethyl styrene, N,N-diethyl-p-aminomethyl styrene, vinyl pyridine, vinyl xylene, monochlorostyrene, dichlorostyrene, monobromostyrene, fluorostyrene, ethyl styrene and vinyl naphthalene. Among these aromatic vinyl compounds, preferred are styrene and α-methyl styrene. These aromatic vinyl compounds may be used in combination of any two or more thereof.

Examples of the cyanided vinyl compound include acrylonitrile and methacrylonitrile. Among these cyanided vinyl compounds, preferred is acrylonitrile. These cyanided vinyl compounds may be used in combination of any two or more thereof.

Examples of the (meth)acrylic acid ester compound include acrylic acid esters such as methyl acrylate, ethyl acrylate, propyl acrylate, butyl acrylate, amyl acrylate, hexyl acrylate, octyl acrylate, 2-ethylhexyl acrylate, cyclohexyl acrylate, dodecyl acrylate, octadecyl acrylate, phenyl acrylate and benzyl acrylate; and methacrylic acid esters such as methyl methacrylate, ethyl methacrylate, propyl methacrylate, butyl methacrylate, amyl methacrylate, hexyl methacrylate, octyl methacrylate, 2-ethylhexyl methacrylate, cyclohexyl methacrylate, dodecyl methacrylate, octadecyl methacrylate, phenyl methacrylate and benzyl methacrylate. Among these (meth)acrylic acid ester compounds, especially preferred are methyl methacrylate and butyl acrylate.

Examples of the maleimide-based compound include maleimide, N-methyl maleimide, N-butyl maleimide, N-(p-methylphenyl)maleimide, N-phenyl maleimide and N-cyclohexyl maleimide. Among these maleimide-based compounds, especially preferred are N-phenyl maleimide and N-cyclohexyl maleimide.

Examples of the carboxyl group-containing vinyl compound include acrylic acid and methacrylic acid.

Examples of the acid anhydride group-containing unsaturated monomer include maleic anhydride, itaconic anhydride and citraconic anhydride. Among these acid anhydride group-containing unsaturated monomers, especially preferred is maleic anhydride. Examples of the epoxy group-containing unsaturated monomer include glycidyl methacrylate and allyl glycidyl ether. Among these acid anhydride group-containing unsaturated monomers, especially preferred is glycidyl methacrylate.

Examples of the hydroxyl group-containing vinyl compound include 3-hydroxy-1-propene, 4-hydroxy-1-butene, cis-4-hydroxy-2-butene, trans-4-hydroxy-2-butene, 3-hydroxy-2-methyl-1-propene, 2-hydroxyethyl acrylate, 2-hydroxyethyl methacrylate and p-hydroxystyrene. Among these hydroxyl group-containing vinyl compounds, especially preferred is 2-hydroxyethyl methacrylate.

Examples of the amide group-containing vinyl compound include acrylamide and methacrylamide. Among these amide group-containing vinyl compounds, especially preferred is acrylamide.

Examples of the amino group-containing vinyl compound include acryl amine, dimethylaminomethacrylate, diethylaminomethacrylate and dimethylaminomethacrylate.

Examples of the oxazoline group-containing vinyl compound include vinyl oxazoline and the like. Meanwhile, the monomer components other than the above aromatic vinyl compounds may be used in combination of any two or more thereof.

When using the aromatic vinyl compound and the cyanided vinyl compound as the monomer component comprising the aromatic vinyl compound in the ultrahigh molecular weight aromatic vinyl-based resin (B), the ratio of an amount of the aromatic vinyl compound used to an amount of the cyanided vinyl compound used (aromatic vinyl compound/cyanided vinyl compound) is usually 95 to 50/5 to 50% by mass, preferably 75 to 65/25 to 35% by mass and more preferably 73 to 69/27 to 31% by mass from the standpoint of a good balance between coloring property and processability. When the amount of the cyanided vinyl compound used is more than 50% by mass, the resin composition as a final aimed product tends to be deteriorated in thermal stability. When the amount of the cyanided vinyl compound used is less than 5% by mass, the resin composition as a final aimed product tends to be deteriorated in ductility.

When using the monomer component other than the aromatic vinyl compound and the cyanided vinyl compound as the monomer component comprising the aromatic vinyl compound in the ultrahigh molecular weight aromatic vinyl-based resin (B), the amount of the monomer component other than the aromatic vinyl compound and the cyanided vinyl compound used is usually 0 to 30% by mass, preferably 0 to 20% by mass and more preferably 0 to 10% by mass based on a total amount of the whole monomer components. When the amount of the monomer component other than the aromatic vinyl compound and the cyanided vinyl compound used is more than 30% by mass, the resin composition as a final aimed product tends to be deteriorated in thermal stability.

The weight-average molecular weight of the acetone-soluble component contained in the ultrahigh molecular weight aromatic vinyl-based resin (B) is not less than 2,000,000, preferably not less than 3,000,000 and more preferably not less than 4,000,000. When the weight-average molecular weight of the acetone-soluble component contained in the ultrahigh molecular weight aromatic vinyl-based resin (B) is not less than 2,000,000, the resin composition as a final aimed product is excellent in dimensional stability, moldability, strength and scratch resistance. The weight-average molecular weight of the acetone-soluble component contained in the ultrahigh molecular weight aromatic vinyl-based resin (B) may be measured as follows. That is, after dissolving the resin in acetone and separating an acetone-soluble component therefrom, followed by drying the acetone-soluble component. Then, the dried acetone-soluble component is dissolved in tetrahydrofuran, and the resulting solution is subjected to gel permeation chromatography (GPC) to determine the weight-average molecular weight of the acetone-soluble component in terms of polystyrene using the polystyrene as a reference standard substance.

The method of producing the ultrahigh molecular weight aromatic vinyl-based resin (B) used in the present invention may be controlled by varying kinds and amounts of the polymerization initiator, chain transfer agent, emulsifier, solvent, etc. The method of obtaining the ultrahigh molecular weight aromatic vinyl-based resin (B) used in the present invention may also be controlled by varying the addition method and addition time of the monomer component, polymerization time, polymerization temperature, etc. The molecular weight of the ultrahigh molecular weight aromatic vinyl-based resin (B) may be increased by controlling an amount of the chain transfer agent added, etc., but is preferably increased by controlling an amount of the polymerization initiator added. In particular, in the emulsion polymerization using an emulsifier having a low CMC (critical micelle concentration), there may be used the polymerization method in which the monomer component is added intermittently in divided parts in multiple stages using no chain transfer agent but a small amount of a water-soluble polymerization initiator, and further the polymerization temperature is controlled to a relatively low temperature.

The ultrahigh molecular weight aromatic vinyl-based resin (B) may be usually produced by a suspension polymerization method and an emulsion polymerization method. Among these polymerization methods, preferred is an emulsion polymerization method in which the monomer component is added at one time or intermittently in divided parts. In the emulsion polymerization method, there may be used a radical polymerization initiator, an emulsifier, a chain transfer agent, etc. Examples of the radical polymerization initiator include redox-based initiators prepared by combination of an oxidizing agent including organic hydroperoxides such as cumene hydroperoxide, diisopropyl benzene hydroperoxide, p-menthane hydroperoxide and tert-butyl peroxylaurate and a reducing agent such as sugar-containing iron pyrophosphate compounds, sulfoxylate compounds and mixtures of the sugar-containing iron pyrophosphate compounds and the sulfoxylate compounds; persulfates such as potassium persulfate and ammonium persulfate; azo compounds such as azobisisobutyronitrile, dimethyl-2,2′-azobisisobutyrate and 2-carbamoyl azaisobutyronitrile; and organic peroxides such as benzoyl peroxide and lauroyl peroxide. Among these radical polymerization initiators, preferred are water-soluble initiators such as potassium peroxide. Upon production of the resin (B), a reducing agent such as iron sulfate and sodium hydrogen sulfite may also be used in combination with the above radical polymerization initiator.

The amount of the radical polymerization initiator used is usually about 0.01 to 2 parts by mass, preferably about 0.03 to 0.5 part by mass and more preferably about 0.05 to 0.3 part by mass based on 100 parts by mass of the monomer components used. When the amount of the radical polymerization initiator used is less than 0.01 part by mass, the polymerization reaction tends to be hardly initiated in a stable manner. On the other hand, when the amount of the radical polymerization initiator used is more than 2 parts by mass, the polymerization reaction tends to be rapidly initiated, so that the polymerization temperature tends to be hardly controlled owing to large heat generation by heat of polymerization, and the resulting product tends to be lowered in molecular weight.

Examples of the emulsifier include alkali metal salts of rosin acids, alkali metal salts of fatty acids, alkali metal salts of aliphatic alcohol sulfuric acid esters, alkali metal salts of alkyl allyl sulfonic acids, alkali metal salts of dialkyl sulfosuccinic acid esters, alkali metal salts of polyoxyethylene alkyl(phenyl)ether sulfuric acid esters, and alkali metal salts of polyoxyethylenealkylether phosphoric acid esters. Among these emulsifiers, preferred are alkali metal salts of fatty acids.

The amount of the emulsifier used is usually 0.1 to 10 parts by mass and preferably 0.3 to 5 parts by mass based on 100 parts by mass of the monomer components used. When the amount of the emulsifier used is less than 0.1 part by mass, the latex upon the emulsion polymerization tends to be deteriorated in stability. On the other hand, when the amount of the emulsifier used is more than 10 parts by mass, the resulting resin composition tends to be deteriorated in thermal stability.

Examples of the chain transfer agent include mercaptans such as octyl mercaptan, n-dodecyl mercaptan, t-dodecyl mercaptan, n-hexyl mercaptan, n-hexadecyl mercaptan, n-tetradecyl mercaptan and t-tetradecyl mercaptan; hydrocarbons such as tetraethyl thiuram sulfide, carbon tetrachloride, ethylene bromide and pentane phenyl ethane; terpenes; and acrolein, methacrolein, allyl alcohol, 2-ethylhexyl thioglycol and an α-methyl styrene dimer. These chain transfer agents may be used in combination of any two or more thereof. The amount of the chain transfer agent used is usually 0.02 to 1 part by mass based on 100 parts by mass of the monomer components. When the amount of the chain transfer agent used is less than 0.02 part by mass, it may be difficult to exhibit the effect of using the chain transfer agent as a molecular weight controller. When the amount of the chain transfer agent used is more than 1 part by mass, the resulting thermoplastic resin tends to be decreased in molecular weight.

The amount of water used in the emulsion polymerization is preferably 110 to 330 parts by mass, more preferably 120 to 300 parts by mass and still more preferably 130 to 270 parts by mass based on 100 parts by mass of the monomer components used. When the amount of water used in the emulsion polymerization is less than 110 parts by mass, the polymerization temperature tends to be hardly controlled owing to large heat generation by heat of polymerization, so that the resulting thermoplastic resin tends to be decreased in molecular weight. When the amount of water used in the emulsion polymerization is more than 330 parts by mass, the polymerization rate tends to be lowered so that the reaction tends to require an undesirably prolonged time.

When the polymerization temperature is raised, the chain transfer constant for the monomer tends to become large, so that the molecular weight of the resulting product tends to be hardly increased. The polymerization temperature is preferably 50 to 98° C. and more preferably 55 to 98° C. The inside temperature of the reactor used upon the polymerization is preferably controlled to the above-specified polymerization temperature range. When the polymerization temperature is lower than 50° C., the polymerization initiator tends to hardly undergo decomposition so that the initiation of polymerization tends to become unstable. On the other hand, when the polymerization temperature is higher than 98° C., the production rate of radicals tends to be too high, so that the molecular weight of the resulting product tends to be hardly increased. Further, the polymerization time is preferably not less than 3 hr. When the polymerization time is less than 3 hr, the polymerization temperature tends to be hardly controlled owing to large heat generation by heat of polymerization, so that the resulting thermoplastic resin tends to be undesirably decreased in molecular weight.

When the ultrahigh molecular weight aromatic vinyl-based resin (B) is produced by the emulsion polymerization method, since the polymerization activity tends to be lowered owing to adverse influence of dissolved oxygen in the latex, it is required to fully replace an atmosphere in the reaction system with nitrogen. The concentration of oxygen before the polymerization is usually not more than 3,000 ppm and preferably not more than 1,000 ppm. In the preferred embodiment, the dissolved oxygen is removed with an oxygen scavenger such as hydrosulfite salts.

The latex obtained upon the production of the ultrahigh molecular weight aromatic vinyl-based resin (B) is subjected to recovery steps such as coagulation and washing, and then dried to obtain a powder thereof. Examples of the coagulant used in the coagulation step include aqueous solutions of sulfuric acid, magnesium sulfate, calcium chloride, aluminum sulfate, etc.

The ultrahigh molecular weight aromatic vinyl-based resin (B) used in the present invention may be a commercially available product. Examples of the commercially available product of the styrene-acrylonitrile copolymers include “Blendex 869” produced by Chemtura Corp.

<Profile Extrusion Molding Resin Composition>

In the profile extrusion molding resin composition according to the Embodiment 1 of the present invention, the proportion between the rubber-reinforced aromatic vinyl-based resin (A) and the ultrahigh molecular weight aromatic vinyl-based resin (B) is 80 to 99.9% by mass/0.1 to 20% by mass, preferably 85 to 99.5% by mass/0.5 to 15% by mass and more preferably 90 to 99% by mass/1 to 10% by mass (with the proviso that a total amount of the components (A) and (B) is 100% by mass).

When the proportion between the rubber-reinforced aromatic vinyl-based resin (A) and the ultrahigh molecular weight aromatic vinyl-based resin (B) is out of the above-specified range, the resin composition as a final aimed product tends to be deteriorated in balance between strength, heat resistance and processability. Also, when the proportion of the ultrahigh molecular weight aromatic vinyl-based resin (B) is too small, drawdown tends to be caused upon the profile extrusion, so that the resulting resin molded product tends to suffer from formation of crossing streaks on a surface thereof or variation in thickness of the resin molded product.

In the resin composition according to the present invention, the proportion between the rubber-reinforced aromatic vinyl-based resin (A1), the ethylene-α-olefin-based rubber-reinforced aromatic vinyl-based resin (A2) and the ultrahigh molecular weight aromatic vinyl-based resin (B) is 60 to 99.8% by mass/0.1 to 20% by mass/0.1 to 20% by mass, preferably 70 to 99% by mass/0.5 to 15% by mass/0.5 to 15% by mass, and more preferably 80 to 98% by mass/1 to 10% by mass/1 to 10% by mass (with the proviso that a total amount of the rubber-reinforced aromatic vinyl-based resin (A1), the ethylene-α-olefin-based rubber-reinforced aromatic vinyl-based resin (A2) and the ultrahigh molecular weight aromatic vinyl-based resin (B) is 100% by mass).

When the proportion between the rubber-reinforced aromatic vinyl-based resin (A1), the ethylene-α-olefin-based rubber-reinforced aromatic vinyl-based resin (A2) and the ultrahigh molecular weight aromatic vinyl-based resin (B) is out of the above-specified range, the resin composition as a final aimed product tends to be deteriorated in balance between strength, heat resistance and processability, as well as the resulting molded product tends to be deteriorated in appearance. Also, when the proportion of the ethylene-α-olefin-based rubber-reinforced aromatic vinyl-based resin (A2) is too small, the resulting resin composition tends to be deteriorated in kneading property upon the extrusion. In addition, when the proportion of the ultrahigh molecular weight aromatic vinyl-based resin (B) is too small, drawdown tends to be caused upon the profile extrusion, so that the resulting resin molded product tends to deteriorated in appearance.

The lubricant (C) used in the present invention is not particularly limited. Examples of the lubricant (C) include polyolefin waxes, fatty acid metal salts, fatty acid amides and fatty acid esters.

The polyolefin waxes used in the present invention are relatively low-molecular weight waxes usually having a number-average molecular weight of 100 to 10,000 among homopolymers and copolymers of olefins. Specific examples of the polyolefin waxes include polyethylene waxes, polypropylene waxes and olefin copolymer waxes (for example, ethylene copolymer waxes), as well as partially oxidized products or mixtures of these waxes. Meanwhile, the structure of the polyolefin waxes may be either a linear structure or a branched structure. These polyolefin waxes may be used in combination of any two or more thereof.

Examples of the olefin copolymers include copolymers produced from two or more kinds of olefins such as ethylene, propylene, 1-butene, 1-hexene, 1 decene, 4-methyl-1-butene and 4-methyl-1-pentene, and copolymers of these olefins with monomers which are copolymerizable with these olefins, for example, polymerizable monomers including unsaturated carboxylic acids or acid anhydrides thereof [such as (meth)acrylic acid and maleic anhydride], and polymerizable monomers such as (meth)acrylic acid esters [e.g., (meth)acrylic acid alkyl esters such as methyl (meth)acrylate and ethyl (meth)acrylate]. These copolymers may be in the form of a random copolymer, a block copolymer or a graft copolymer.

The number-average molecular weight of the polyolefin waxes is usually 800 to 8,000, preferably 900 to 7,000, and more preferably 1,000 to 6,000 from the standpoint of a good kneading property. The viscosity of the polyolefin waxes (as measured at 140° C.) is usually 100 to 10,000 cps, and preferably 100 to 5,000 cps. The polyolefin waxes whose viscosity falls within the above-specified range is excellent in kneading property.

Examples of the commercially available products of the polyolefin waxes include “NEOWAX ACL” produced by Yasuhara Chemical Co., Ltd., “Hi-WAX 100P” and “Hi-WAX 400P” both produced by Mitsui Chemicals, Inc., and “Licowax PE-520” produced by Clariant Corp.

Examples of the fatty acid metal salts include calcium stearate, magnesium stearate, zinc stearate, aluminum stearate and barium stearate. Examples of the fatty amides include stearic amide and ethylenebis-stearic amide. Examples of the fatty acid esters include stearyl stearate, stearic monoglyceride, stearic diglyceride and stearic triglyceride.

The lubricant (C) used in the present invention when mixed with the vinyl chloride-based resins preferably has a melting point of not lower than 80° C., more preferably not lower than 95° C., still more preferably not lower than 100° C., and further still more preferably not lower than 105° C. When the melting point of the lubricant (C) is lower than 80° C., the lubricant (C) tends to be melted earlier than the other components upon melt-kneading the resin composition according to the present invention with the vinyl chloride-based resin, so that the below-mentioned inorganic filler (D) may fail to be well dispersed, and therefore the effects of enhancing a rigidity and a dimensional stability (reduction in linear expansion) as well as the surface appearance of the resulting molded product tend to be insufficient. Meanwhile, the measuring conditions of the melting point of the lubricant (C) used in the present invention are as follows. When no clear melting point is present, the melting point of the lubricant (C) is regarded as being less than 80° C.

### (Measuring Conditions)

Measuring apparatus: “TA DSC 2910 Model”

Maker: TA-Instruments

Measuring conditions: according to JIS K-7121

Flow rate of nitrogen gas: 50 mL/min

Temperature rise rate: 20° C./min

The content of the lubricant (C) in the resin composition according to the present invention is 0.1 to 20 parts by mass, preferably 0.2 to 15 parts by mass, and more preferably 0.5 to 10 parts by mass based on 100 parts by mass of the above base resin component. When the content of the lubricant (C) falls with the above-specified range, the resin composition as a final aimed product is excellent in kneading property and balance between various properties.

Examples of the inorganic filler (D) used in the present invention include wollastonite, talc, glass fibers, glass balloons, metal powder, carbon fibers, carbon nanotubes, alumina fibers, silicon carbide fibers, ceramic fibers, ceramic fibers, gypsum fibers, potassium titanate fibers, stainless steel fibers, steel fibers and boron whisker fibers. When the inorganic filler is in the form of fibers, the fiber-shaped filler is oriented in the flowing direction of the resin upon producing the profile extrusion resin molded product using the resin composition according to the present invention, so that sufficient effects of enhancing a rigidity and a dimensional stability (reduction in linear expansion) of the resulting molded product can be obtained. Among these inorganic fillers, preferred are wollastonite and glass fibers from the viewpoint of attaining the above effects. In particular, the wollastonite is more preferred because it has a Moh's hardness as low as 4 to 6, and therefore hardly causes abrasion of an inner wall of a barrel of a molding machine, screws or a die or a sizing die.

The wollastonite used in the present invention comprises SiO₂ and CaO substantially in equal amounts as main components, and Al₂O₃ or Fe₂O₃ as trace components. The wollastonite has an appearance of a white powder, and an acicular shape or a rectangular column shape. From the viewpoints of a reinforcing effect and a dimensional stability, the wollastonite has a fiber length of usually 30 to 400 μm and preferably 50 to 300 μm, a fiber diameter of usually 2 to 20 μm and preferably 3 to 15 μm, and an average aspect ratio of usually 5 to 50 and preferably 10 to 30.

Examples of commercially available products of the wollastonite include “SH-800” (acicular wollastonite; fiber length: 110 μm×fiber diameter: 6.5 μmφ) produced by Kinsei Matec Co., Ltd., “NYGLOS 8” (acicular wollastonite; fiber length: 136 μm×fiber diameter: 8 μmφ) produced by Tomoe Engineering Co., Ltd., and “SAIKATEC H-08” (acicular wollastonite; fiber length: 200 μm×fiber diameter: 8 μmφ) produced by Keiwa Rozai Co., Ltd.

The talc used in the present invention is usually hydrous magnesium silicate as a kind of clay mineral, and has a composition represented by the formula: (MgO)ₓ(SiO₂)_{y}.zH₂O (wherein x, y and z are each a positive value), typically [(MgO)₃(SiO₂)₄H₂O]. Also, a part of Mg in the talc may be replaced with a divalent metal ion such as Ca²⁺. The particle diameter of the talc is not particularly limited, and the average particle diameter of the talc as measured by a laser scattering method is usually 0.5 to 50 μm. When the average particle diameter of the talc is less than 0.5 μm, the talc tends to be insufficient in dispersibility, so that the resulting molded product tends to fail to exhibit a sufficiently reduced linear expansion coefficient. On the other hand, when the average particle diameter of the talc is more than 50 μm, the resulting molded product tends to be insufficient in appearance. The talc preferably has a shape with a large aspect ratio from the viewpoint of attaining a sufficient effect of enhancing a dimensional stability (reduction in linear expansion). Examples of commercially available products of the talc include “MICRO-ACE Series” produced by Nippon Talc Co., Ltd., and the like.

The glass fibers used in the present invention are not particularly limited, and any suitable known glass fibers may be used. Examples of a raw glass material of the glass fibers include silicate glass, borosilicate glass and phosphate glass. Examples of kind of glass used in the glass fibers include E glass, C glass, A glass, S glass, M glass, AR glass and L glass. Among these glass materials, E glass and C glass are preferably used.

The glass fibers may be surface-treated with known sizing agents comprising synthetic resin emulsions, water-soluble synthetic resins, coupling agents (such as amine-based, silane-based, epoxy-based, etc.), film-forming agents, lubricants, surfactants, antistatic agents or the like.

The fiber length of the glass fibers is not particularly limited. The glass fibers may be of either a long fiber type (roving), a short fiber type (chopped strand) or combination of these fibers. Also, the sectional shape of the glass fibers is not particularly limited. The glass fibers have an average fiber length of usually 1 to 10 mm and preferably 2 to 6 mm, and an average fiber diameter of usually 5 to 25 μm and preferably 8 to 20 μm.

The residual average fiber length of the glass fibers which remain in the molded product obtained using the resin composition according to the present invention is usually 150 to 1,000 μm, preferably 200 to 800 μm and more preferably 250 to 700 μm. When the residual average fiber length of the glass fibers is too short, the effects of improving molding shrinkage and rigidity tend to be lowered. When the residual average fiber length of the glass fibers is too long, the resin composition tends to be deteriorated in flowability, and the resulting molded product tend to be deteriorated in surface appearance. Meanwhile, the residual average fiber length of the glass fibers may be measured, for example, by cutting out a part of the molded product, heating the cut part of the molded product to 800° C. to decompose a resin component therein, and subjecting the remaining glass fibers to image analysis to determine a fiber length thereof.

The content of the inorganic filler (D) in the resin composition according to the present invention is 10 to 100 parts by mass, preferably 15 to 90 parts by mass and more preferably 20 to 80 parts by mass based on 100 parts by mass of the above base resin component. When the content of the inorganic filler (D) is less than 10 parts by mass, the effects of improving a rigidity and a dimensional stability (reduction in linear expansion) of the resulting molded product tends to be insufficient. On the other hand, when the content of the inorganic filler (D) is more than 100 parts by mass, the resulting molded product tends to be deteriorated in surface appearance and impact strength, or the resulting resin composition tends to be hardly kneaded.

The resin composition (I) according to the present invention which comprises the above base resin component, the lubricant (C) and the inorganic filler (D) may be suitably used as such in the applications for profile extrusion molding. However, the resin composition may be used as a resin composition (II) for profile extrusion molding which further comprises a vinyl chloride-based resin (E).

As the vinyl chloride-based resin (E) used in the present invention, in addition to polyvinyl chloride, there may also be used all of resins obtained by polymerizing a mixture of vinyl chloride and a vinyl compound copolymerizable with the vinyl chloride by an ordinary polymerization method such as a suspension polymerization method, a bulk polymerization method, a finely-divided suspension polymerization method and an emulsion polymerization method, and resins obtained by graft-copolymerizing vinyl chloride to ethylene-vinyl acetate copolymers, ethylene-ethyl acrylate copolymers or chlorinated polyethylenes, etc.

Examples of the vinyl compound to be copolymerized with vinyl chloride include vinyl esters such as vinyl acetate and vinyl propionate; acrylic acid esters such as methyl acrylate and butyl acrylate; methacrylic acid esters such as methyl methacrylate and ethyl methacrylate; maleic acid esters such as butyl maleate and diethyl maleate; fumaric acid esters such as dibutyl fumarate and diethyl fumarate; vinyl ethers such as vinyl methyl ether, vinyl butyl ether and vinyl octyl ether; cyanided vinyl compounds such as acrylonitrile and methacrylonitrile; α-olefins such as ethylene, propylene and styrene; halogenated vinylidene and halogenated vinyl compounds other than vinyl chloride such as vinylidene chloride and vinyl bromide; and phthalic acid esters such as diallyl phthalate. The amount of these vinyl compounds used in terms of a proportion thereof in constituting components of the vinyl chloride-based resin is usually not more than 30% by mass, and preferably not more than 20% by mass. The average polymerization degree of the vinyl chloride-based resin (average polymerization degree as measured according to JIS K-6721) is usually 500 to 1500.

The content of the vinyl chloride-based resin (E) as measured in terms of a proportion of the inorganic filler (D) based on 100 parts by mass of the vinyl chloride-based resin (E) is as follows. That is, the proportion of the inorganic filler (D) based on 100 parts by mass of the vinyl chloride-based resin (E) is usually 3 to 80 parts by mass, preferably 3 to 70 parts by mass and more preferably 5 to 60 parts by mass. When the content of the vinyl chloride-based resin (E) falls within the above-specified range, the resulting molded product is free from defects such as white streaks on a surface thereof and therefore shows a good beauty, as well as has a low linear expansion coefficient, and is capable of producing a profile extrusion resin molded product having an excellent shape stability.

The resin compositions (I) and (II) according to the present invention may further appropriately comprise various additives for resins such as a metal powder, a reinforcing agent, a plasticizer, a compatibilizing agent, a heat stabilizer, a light stabilizer, an antioxidant, an ultraviolet absorber, a dye, a pigment, an antistatic agent and a flame retardant. In addition, the other resins such as polyamides and polycarbonates may be compounded in the resin compositions unless the effects of the present invention are adversely affected.

The resin compositions (I) and (II) according to the present invention may be produced by the method in which the raw materials are compounded and mixed, if required together with various additives for resins, with each other, and kneading the obtained mixture using a kneading machine such as a single-screw extruder, a twin-screw extruder, a Banbury mixer, a pressure kneader and a twin roll. Upon the kneading, the respective components may be kneaded at one time, or may be intermittently added and kneaded in divided parts in multiple stages. The melt-kneading temperature is usually 200 to 300° C. and preferably 220 to 290° C.

In order to produce the resin composition (II) further comprising the vinyl chloride-based resin (E) according to the present invention, in addition to the above production method, there may be used the method in which after producing the resin composition (I) from the respective components except for the vinyl chloride-based resin (E), the resulting mixture is used as a so-called master batch and compounded with the vinyl chloride-based resin (E). The above method has such an advantage that the inorganic filler (D) is more efficiently dispersed in the vinyl chloride-based resin (E), resulting in excellent productivity.

The resin compositions (I) and (II) according to the present invention may be formed into a resin molded product having a desired shape by a profile extrusion molding method. The thus produced profile extrusion molded product of the present invention is excellent in strength, impact resistance, heat resistance, scratch resistance, surface appearance and shaping property, and therefore effectively used as sashes or rain gutters in building application fields, or various parts or housings in electric and electronic application fields, sundries application fields, vehicular application fields, etc. Among these applications, especially preferred are elongated members such as sashes and rain gutters.

An example of the method for producing the profile extrusion resin molded product of the present invention is as follows. That is, the resin is plasticized in an extruder and formed into a desired shape through a die fitted to a tip end of the extruder, and the resulting extruded product is sized using a sizing plate or a sizing die and then cooled and solidified through a water bath, etc., followed by cutting the resulting product. The shape of the profile extrusion molded product may be usually a concave shape or an L shape in cross section, or a complicated shape such as a window frame shape. The molded product extruded from the die is further passed through a sizing unit while regulating a dimension or shape thereof, and then cooled and solidified, followed by taking up the resulting product.

### EXAMPLES

The present invention is described in more detail by the following examples, but these examples are only illustrative and not intended to limit a scope of the present invention thereto. Meanwhile, in the following examples, etc., the “part(s)” and “%” represent “part(s) by mass” and “% by mass”, respectively, unless otherwise specified. Also, the evaluation methods used in the present invention are as follows.

### (1) Flexural Strength and Flexural Modulus:

The flexural strength and flexural modulus were measured at room temperature (23° C.) using a precision universal tester “AUTOGRAPH AG5000E Model” manufactured by Shimadzu Seisakusho Corp., according to ISO testing method 178. The unit of the measured values was MPa.

### (2) Impact Resistance:

According to ISO testing method 179, the Charpy test impact strength (Edgewise Impact; notched) was measured at room temperature (23° C.). The measuring conditions were as follows. The unit of the measured value was KJ/m².

### (Measuring Conditions)

Type of test piece: Type 1

Type of notch: Type A

Load: 2 J

### (3) Tensile Strength:

The tensile strength was measured at room temperature (23° C.) using a precision universal tester “AUTOGRAPH AG5000E Model” manufactured by Shimadzu Seisakusho Corp., according to ISO testing method 527. The elastic stress rate was 5 mm/min, and the unit of the measured value was MPa.

### (4) Deflection Temperature Under Load:

A test piece having a width of 10 mm, a height of 4 mm and a length of 80 mm was prepared by an injection molding method. The deflection temperature under load of the test piece was measured under a load of 1.82 MPa by Flat-wise method according to ISO testing method 75 (Under load). The unit of the measured value was ° C. The test result was evaluated as follows. That is, the higher the deflection temperature under load, the more excellent the heat resistance.

### (5) Scratch Resistance:

(i) An extrusion molded sheet (38 mm×130 mm×0.3 mm), a double wall corrugated fiberboard having a structure of front-side linerboard/corrugating medium/rear-side linerboard (50 mm×50 mm×5 mm), an iron plate (120 mm×25 mm; weight: 50 g) and a vibrating container (inner dimension: 150 mm×70 mm) were prepared.
(ii) The double wall corrugated fiberboard was adhered to a central portion of an inner bottom surface of the vibrating container such that the vibrating direction of the vibrating container was perpendicular to the direction of the corrugating medium of the double wall corrugated fiberboard.
(iii) The iron plate was adhered onto the extrusion molded sheet to prepare a laminate.
(iv) The laminate was placed on the double wall corrugated fiberboard within the vibrating container such that the extrusion molded sheet came into contact with the double wall corrugated fiberboard.
(v) The vibrating container was placed on a vibrating apparatus (“MULTISHAKER MMS” manufactured by Tokyo Rikakikai Co., Ltd.) and vibrated reciprocatively at 200 rpm for 60 min. Thereafter, the amount of a powder deposited onto the double wall corrugated fiberboard was visually observed to evaluate a scratch resistance of the molded sheet according the following three ratings (A: no powder adhered; B: a small amount of powder adhered; C: a large amount of powder adhered).

### (6) Kneading Property:

Using a single-screw extruder (“NVC-50” manufactured by Nakatani Kikai Co., Ltd.), pellets were produced at a cylinder temperature of 190 to 220° C., and the appearance of the pellets were visually observed to evaluate a kneading property thereof according to the following two ratings (A: no phase separation occurred; C: phase separation occurred).

### (7) Surface Appearance of Profile Extrusion Resin Molded Product:

The obtained profile extrusion resin molded product was visually observed and evaluated according to the following two ratings (A: no streaks occurred on a surface of the resin molded product; C: streaks occurred on a surface of the resin molded product). However, oriented patterns of the inorganic filler were ignored upon the above evaluation.

### (8) Shape Stability of Profile Extrusion Resin Molded Product:

The sectional shape of the obtained profile extrusion resin molded product was visually observed to evaluate a shape stability thereof according to the following three ratings assuming that a sectional area of the sizing die was 100% (A: the area of a sectional shape of the resin molded product was not less than 80%; B: the area of a sectional shape of the resin molded product was less than 80% and not less than 60%; C: the area of a sectional shape of the resin molded product was less than 60%).

### (9) Drawdown Property:

Upon the profile extrusion molding, the resin molded product extruded between the die and the sizing die was visually observed to ascertain whether or not drawdown of the resin occurred, and evaluate a drawdown property thereof according to the following two ratings (A: no drawdown of the resin molded product was observed; C: drawdown of the resin molded product was observed).

### (10) Linear Expansion Coefficient:

A test piece (50 mm×10 mm×4 mm) was produced by an injection molding method. The obtained test piece was annealed at 80° C. for 2 hr, and then a length of the resin molded product as a reference was measured in an atmosphere of 23° C. Thereafter, the resin molded product was heated to 70° C. to measure a length thereof at 70° C. and obtain an average rate of change in length thereof per 1° C. between 23° C. and 70° C. as a linear expansion coefficient of the resin molded product. The unit of the measured value was “×10⁻⁵/° C.”. Meanwhile, the length of the molded product was measured using a laser micrometer “3Z4L-S506R” manufactured by OMRON Corp.

### <ABS Resin>

As the rubber-reinforced aromatic vinyl-based resin (A1), there was used a commercially available ABS resin “ABS150” produced by Techno Polymer Co., Ltd., which comprised an acetone-soluble component having an intrinsic viscosity [η] of 0.45 dL/g (as measured at 30° C. in methyl ethyl ketone) and a weight-average molecular weight of not more than 1,000,000.

### <ASA Resin>

As the rubber-reinforced aromatic vinyl-based resin (A1), there was used an ASA resin produced through the following procedures (i) to (iii).

### (i) Production of Acryl-Based Rubber Polymer Latex:

99 parts by mass of n-butyl acrylate (hereinafter referred to merely as “BA”) and 1 part by mass of allyl methacrylate (hereinafter referred to merely as “AMA”) were mixed with each other to prepare a monomer mixture (I). A 5 L glass reactor equipped with a stirring device, a raw material/assistant addition device, a thermometer, a heating device, etc., was charged with 150 parts by mass of water, 1 part by mass of disproportionated potassium rosinate as an emulsifier, 1.5 parts by mass of a sodium salt of β-naphthalenesulfonic acid-formalin condensate and 1 part by mass of sodium hydrogencarbonate as an electrolyte, and an inside temperature of the reactor was raised to 60° C. under a nitrogen flow while stirring. At the time at which the inside temperature of the reactor reached 60° C., 10.1 parts by mass of the monomer mixture (I) were charged into the reactor, and the contents of the reactor were further heated to 75° C.

Next, at the time at which the inside temperature of the reactor reached 75° C., an aqueous solution prepared by dissolving 0.025 part of potassium persulfate (hereinafter referred to merely as “KPS”) in 2.0 parts of water was charged into the reactor, and then polymerization of the contents of the reactor was initiated at the same temperature. After the elapse of 1 hr from initiation of the polymerization, an aqueous solution prepared by dissolving 0.5 part of a sodium soap of a higher fatty acid in 12 part of water while warming the solution to a temperature of about 60° C., and an aqueous solution prepared by dissolving 0.15 part of KPS in 80 parts of water were charged into the reactor. Immediately after charging the aqueous solutions into the reactor, 89.9 parts of the monomer mixture (I) were continuously added to the reactor over 2 hr.

Immediately after continuously adding the monomer mixture (I), an aqueous solution prepared by dissolving 0.06 part of KPS in 5.0 parts of water was charged into the reactor, and an inside temperature of the reactor was raised from 75° C. to 80° C. After being raised to 80° C., the inside temperature of the reactor was further held at 80° C. for 1 hr and 30 min, and then the polymerization reaction was terminated, thereby obtaining an acryl-based rubber polymer latex. The conversion rate upon the polymerization reaction was 97%. The thus obtained acryl-based rubber polymer latex had a weight-average particle diameter of 284 nm. The weight-average particle diameter of the acryl-based rubber polymer particles having a particle diameter of less than 350 nm was 127 nm, and the content thereof was 77%, whereas the weight-average particle diameter of the acryl-based rubber polymer particles having a particle diameter of not less than 350 nm was 806 nm, and the content thereof was 23%. Also, the content of the acryl-based rubber polymer particles having a particle diameter of 300 to 400 nm was 5%.

### (ii) Production of Graft Polymer:

73 parts of styrene (hereinafter referred to merely as “St”) and 27 parts of acrylonitrile (hereinafter referred to merely as “AN”) were mixed to prepare a monomer mixture (II). A 5 L glass reactor equipped with a stirring device, a raw material/assistant addition device, a thermometer, a heating device, etc., was charged with 100 parts of the above acryl-based rubber polymer latex (in terms of a solid content thereof) and 110 parts of water, and an inside temperature of the reactor was raised to 40° C. under a nitrogen flow while stirring. At the time at which the inside temperature of the reactor reached 40° C., 86% of an aqueous solution prepared by dissolving 0.3 part of glucose, 1.2 parts of sodium pyrophosphate and 0.01 part of ferrous sulfate in 20 parts of water (hereinafter referred to merely as “RED aqueous solution”) and 30% of an aqueous solution prepared by dissolving 0.4 part of t-butyl hydroperoxide (hereinafter referred to merely as “BHP”) and 2.4 parts of disproportionated potassium rosinate in 30 parts of water (hereinafter referred to merely as “CAT aqueous solution”) were charged into the reactor. Immediately after charging the aqueous solutions into the reactor, the monomer mixture (II) and the CAT aqueous solution were continuously added over 3 hr and over 3 hr and 30 min, respectively, whereby polymerization of the contents of the reactor was initiated. The reaction temperature was raised to 75° C. upon initiation of the polymerization.

Thereafter, the reaction temperature was held at 75° C. After the elapse of 180 min from initiation of the polymerization, remaining 14% of the RED aqueous solution were charged into the reactor, and maintained at 75° C. for 60 min, and then the polymerization reaction was terminated. The obtained copolymer latex was coagulated, washed with water and then dried, thereby obtaining a graft polymer (A1) in the form of a powder. The conversion rate upon the polymerization reaction was 98%, the graft percentage was 79%, and the acetone-soluble component in the resulting polymer has an intrinsic viscosity [η] of 0.45 dL/g (as measured at 30° C. in methyl ethyl ketone).

(iii) Production of ASA Resin:

40 parts by mass of the above graft polymer (A1), 24 parts by mass of the below-mentioned AS resin (1), 36 parts by mass of the below-mentioned AS resin (2), 0.2 part by mass of an antioxidant “ADEKASTAB AO-50F” and 0.3 part by mass of calcium stearate are compounded and mixed with each other, and melted and kneaded using a vented twin-screw extruder at a cylinder temperature of 210° C. to obtain an ASA resin. As a result, it was confirmed that the thus obtained ASA resin comprised an acetone-soluble component having an intrinsic viscosity [η] of 0.59 dL/g (as measured at 30° C. in methyl ethyl ketone) and a weight-average molecular weight of not more than 1,000,000.

### <AS Resin (1)>

There was used a styrene-acrylonitrile copolymer having a styrene unit content of 70.5% and an acrylonitrile unit content of 29.5% and exhibiting an intrinsic viscosity [η] of 0.7 dL/g (as measured at 30° C. in methyl ethyl ketone).

### <AS Resin (2)>

There was used a styrene-acrylonitrile copolymer having a styrene unit content of 65% and an acrylonitrile unit content of 35% and exhibiting an intrinsic viscosity [η] of 0.54 dL/g (as measured at 30° C. in methyl ethyl ketone).

### <AES Resin>

As the rubber-reinforced aromatic vinyl-based resin (A2), there was used the AES resin produced through the following procedures (i) and (ii).

(i) A 20 L stainless steel autoclave equipped with a ribbon-type stirring device, an assistant continuous addition device, a thermometer, etc., was charged with 22 parts of an ethylene-α-olefin-based rubber (ethylene/propylene=78/22 (%); Mooney viscosity (ML₁₊₄, 100° C.): 20; ethylene-propylene copolymer), 55 parts of styrene, 23 parts of acrylonitrile, 0.5 part of t-dodecyl mercaptan and 110 parts of toluene. The inside temperature of the autoclave was raised to 75° C., and the contents of the autoclave were stirred for 1 hr to prepare a uniform solution. Thereafter, 0.45 part of t-butyl peroxyisopropyl monocarbonate was added to the autoclave, and the inside temperature of the autoclave was further raised to 100° C. After reaching 100° C., the contents of the autoclave were subjected to polymerization reaction at a stirring rotating speed of 100 rpm while maintaining the inside temperature of the autoclave at 100° C.
(ii) At the time at which 4 hours has elapsed from initiation of the polymerization reaction, the inside temperature of the autoclave was raised to 120° C., and the polymerization reaction was further carried out for 2 hr while maintaining the reaction temperature at 120° C., and then terminated. Thereafter, the inside temperature of the autoclave was cooled down to 100° C., and 0.2 part of octadecyl-3-(3,5-di-t-butyl-4-hydroxyphenol)propionate was added thereto. The resulting reaction mixture was withdrawn from the autoclave and subjected to steam distillation to remove the unreacted raw materials and solvent therefrom. Further, the obtained product was subjected to deaeration treatment using a 40 mmφ) vented extruder (cylinder temperature: 220° C.; vacuum degree: 760 mmHg) to remove substantially a whole amount of volatile components therefrom and obtain pellets. The thus obtained ethylene-α-olefin-based rubber-reinforced vinyl-based resin had a graft percentage of 70%, and has an acetone-soluble component having an intrinsic viscosity [η] of 0.4 dL/g and a weight-average molecular weight of not more than 1,000,000, and the content of a rubber component therein was 22%.

### <Ultrahigh Molecular Weight AS Resin>

As the ultrahigh molecular weight aromatic vinyl-based resin (B), there was used the commercially available ultrahigh molecular weight styrene-acrylonitrile copolymer “Blendex 869” produced by Chemtura Corp., which comprised an acetone-soluble component having a weight-average molecular weight of 6,000,000.

### <Lubricant>

### (1) Polyolefin Wax:

There was used the commercially available polyethylene wax “SANWAX 171-P” as a low-molecular weight polyethylene produced by Sanyo Chemical Industries Ltd., which had a number-average molecular weight of 1500 (as measured by steam osmotic pressure method), a viscosity of 180 cps (as measured at 140° C.) and a melting point of 99° C. (as measured according to JIS K-7121).

### (2) Fatty Acid Metal Salt:

There was used magnesium stearate “Mg-St” (tradename) produced by Nitto Kasei Co., Ltd., which had a melting point of 115° C. (as measured according to JIS K-7121).

### (3) Fatty Acid Amide:

There was used ethylenebis(stearic amide) “KAOWAX EB-G” (tradename) produced by Kao Corp., which had a melting point of 147° C. (as measured according to JIS K-7121).

### (4) Fatty Acid Ester:

There was used stearyl stearate “EXCEPEARL SS” (tradename) produced by Kao Corp., which had a melting point of 55° C. (as measured according to JIS K-7121).

### <Inorganic Filler>

### (1) Wollastonite:

There was used the commercially available wollastonite “SH-800” (tradename; acicular wollastonite) produced by Kinsei Matec Co., Ltd., which had a fiber length of 110 μm and a fiber diameter of 6.5 μm.

### (2) Talc

There was used the commercially available generally used talc “TALC MS” (tradename) produced by Nippon Talc Co., Ltd., which had a particle diameter D₅₀ of 14 μm (as measured by a laser diffraction method), an apparent density of 0.35 g/mL (as measured according to JIS K-5101) and a specific surface area of 4.5 m²/g.

### (3) Glass Fibers:

There was used the commercially available chopped strand for thermoplastic resins “CSF3PE-332” (tradename) produced by Nitto Boseki Co., Ltd., which had a fiber length of 3 mm and a fiber diameter of 13 μm.

### <Vinyl Chloride Resin>

There was used the vinyl chloride resin having an average polymerization degree of 1000.

### <Profile Extrusion Molding Resin Composition According to Embodiment 1 of the Present Invention>

### Examples 1A to 5A and Comparative Examples 1A and 2A

The respective components except for the inorganic filler (D) as shown in Table 1 were compounded and mixed with each other with the formulation shown in Table 1 using a Henschel mixer, and then melted and kneaded using a twin-screw extruder “TEX44αII” manufactured by The Japan Steel Works, Ltd. The respective components except for the component (D) were charged into the extruder through a weight feeder from one end thereof. In addition, the component (D) shown in Table 1 was charged into the extruder through a side feeder from a mid portion thereof. The components thus charged were kneaded in the extruder and extruded into pellets. Next, the thus obtained pellets were fully dried, and molded by an injection molding method to prepare a test piece to be evaluated. The thus prepared test piece was evaluated for various properties thereof by the above evaluation methods. The evaluation results are shown in Table 1.

Also, the above pellets were extruded using a 25 mm sheet extruder equipped with a T-die (manufactured by Union Plastic Public Co., Ltd.) at an extrusion temperature of 220° C. and a screw rotating speed of 20 rpm to prepare an extrusion-molded sheet.

Further, the above pellets were subjected to profile extrusion molding process to obtain a profile extrusion resin molded product having a concave sectional shape and a size of 50 mm in width×10 mm in height×2 mm in thickness. The above profile extrusion molding process was carried out using a molding apparatus comprising a single-screw extruder (“PLABOR GT-50-A Type” manufactured by PLABOR Research Laboratory of Plastics Technology Co., Ltd.; full-flighted screw 10 rpm; L/D=30) equipped with a metal die (having a concave shape) and a sizing die (having a concave shape) at a cylinder set temperature of 220° C.

TABLE 1

| | | | | | | Comparative | |
|---|---|---|---|---|---|---|---|
| | Examples | | | | | Examples | |
| | 1A | 2A | 3A | 4A | 5A | 1A | 2A |
| Component A | | | | | | | |
| Rubber-reinforced | 97.5 | 97.5 | 97.5 | 97.5 | 97.5 | 97.5 | 100 |
| aromatic vinyl- | | | | | | | |
| based resin (part) | | | | | | | |
| Component B | | | | | | | |
| Ultrahigh | 2.5 | 2.5 | 2.5 | 2.5 | 2.5 | 2.5 | — |
| molecular weight | | | | | | | |
| aromatic vinyl- | | | | | | | |
| based resin (part) | | | | | | | |
| Component C | | | | | | | |
| Polyolefin wax | 0.5 | 1.0 | 2.0 | 3.0 | — | — | 3.0 |
| (part) | | | | | | | |
| Fatty acid ester | — | — | — | — | 2.0 | — | — |
| (part) | | | | | | | |
| Component D | | | | | | | |
| Wollastonite | 66.7 | 66.7 | 66.7 | 66.7 | 66.7 | 66.7 | 66.7 |
| (part) | | | | | | | |
| Scratch resistance | A | A | A | A | A | C | A |
| Kneading property | A | A | A | A | A | A | A |
| Tensile strength | 38 | 38 | 37 | 37 | 38 | 38 | 38 |
| (MPa) | | | | | | | |
| Flexural strength | 65 | 63 | 63 | 63 | 61 | 66 | 63 |
| (MPa) | | | | | | | |
| Flexural modulus | 6430 | 6400 | 6430 | 6430 | 6220 | 6450 | 6400 |
| (MPa) | | | | | | | |
| Charpy impact | 8 | 8 | 8 | 8 | 7 | 8 | 8 |
| strength (KJ/m²) | | | | | | | |
| Deflection | 87 | 85 | 85 | 84 | 81 | 87 | 85 |
| temperature under | | | | | | | |
| load (° C.) | | | | | | | |
| Surface appearance | A | A | A | A | A | C | A |
| of profile | | | | | | | |
| extrusion resin | | | | | | | |
| molded product | | | | | | | |
| Shape stability of | A | A | A | A | A | A | A |
| profile extrusion | | | | | | | |
| resin molded | | | | | | | |
| product | | | | | | | |
| Drawdown property | A | A | A | A | A | A | C |

### Examples 6A and 7A

In Example 6A, the above resin composition (pellets) obtained in Example 1A as shown in Table 1 was used as a master batch and then blended with a vinyl chloride resin in the form of pellets in such an amount as shown in Table 2. Then, the thus obtained blended material was molded in the same manner as described above to thereby produce a profile extrusion resin molded product. In Example 7A, the above resin composition (pellets) obtained in Example 4A as shown in Table 1 was used as a master batch and then blended with a vinyl chloride resin in the form of pellets in such an amount as shown in Table 2. Then, the thus obtained blended material was molded in the same manner as described above to thereby produce a profile extrusion resin molded product. The evaluation results of the molded products obtained in the respective Examples are shown in Table 2.

### Examples 8A to 21A

The respective components shown in Table 2 were kneaded by the following procedures (i) and (ii).

(i) First, the respective components except for the component (D) as shown in Tables 2 and 3 (but except for the vinyl chloride resin) were mixed with each other using a Henschel mixer, and then melted and kneaded using a twin-screw extruder “TEX44αII” manufactured by The Japan Steel Works, Ltd. The respective components except for the component (D) were charged into the extruder through a weight feeder from one end thereof. In addition, the component (D) was charged into the extruder from a mid portion thereof.
(ii) Next, the thus obtained pellets were fully dried and used as a master batch, and then blended with a vinyl chloride resin in the form of pellets in such an amount as shown in Tables 2 and 3. Then, the thus obtained blended material was molded in the same manner as described in Examples 6A and 7A to thereby produce a profile extrusion resin molded product. The evaluation results of the molded products obtained in the respective Examples are shown in Tables 2 and 3.

### Comparative Examples 3A to 5A

In Comparative Example 3A, the above resin composition (pellets) obtained in Comparative Example 1A as shown in Table 1 was used as a master batch and then blended with a vinyl chloride resin in the form of pellets in such an amount as shown in Table 3. Then, the thus obtained blended material was molded in the same manner as described in Examples 8A to 21A to thereby produce a profile extrusion resin molded product. On the other hand, in Comparative Examples 4A and 5A, in the same manner as defined in Examples 8A to 21A, the respective components as shown in Table 3 (except for the vinyl chloride resin) were mixed with each other using a Henschel mixer, and then melted and kneaded using a twin-screw extruder “TEX44αII” manufactured by The Japan Steel Works, Ltd. The respective components except for the component (D) were charged into the extruder through a weight feeder from one end thereof. In addition, the component (D) was charged into the extruder from a mid portion thereof. Next, the thus obtained pellets were fully dried and used as a master batch, and then blended with a vinyl chloride resin in the form of pellets in such an amount as shown in Table 3. Then, the thus obtained blended material was molded in the same manner as described in Examples 6A and 7A to thereby produce a profile extrusion resin molded product. The evaluation results of the molded products obtained in the respective Comparative Examples are shown in Table 3.

TABLE 2

| | Examples | | | | |
|---|---|---|---|---|---|
| | 6A | 7A | 8A | 9A | 10A |
| Component A | | | | | |
| Rubber-reinforced | 97.5 | 97.5 | 97.5 | 97.5 | 97.5 |
| aromatic vinyl-based | | | | | |
| resin (part) | | | | | |
| Component B | | | | | |
| Ultrahigh molecular | 2.5 | 2.5 | 2.5 | 2.5 | 2.5 |
| weight aromatic vinyl- | | | | | |
| based resin (part) | | | | | |
| Component C | | | | | |
| Polyolefin wax (part) | 0.5 | 3.0 | 8.3 | — | — |
| Fatty acid metal salt | — | — | — | 8.3 | — |
| (part) | | | | | |
| Fatty acid amide | — | — | — | — | 8.3 |
| (part) | | | | | |
| Component D | | | | | |
| Wollastonite (part) | 66.7 | 66.7 | 66.7 | 66.7 | 66.7 |
| Talc (part) | — | — | — | — | — |
| Glass fibers (part) | — | — | — | — | — |
| Component E | | | | | |
| Vinyl chloride resin | 400 | 400 | 400 | 400 | 400 |
| (part) | | | | | |
| (Component D/component | 16.7 | 16.7 | 16.7 | 16.7 | 16.7 |
| E) × 100 (mass %) | | | | | |
| Surface appearance | B | B | B | A | A |
| (white streaks) | | | | | |
| Shape stability of | A | A | B | A | A |
| profile extrusion | | | | | |
| resin molded product | | | | | |
| Linear expansion | 6.2 | 6.2 | 6.2 | 6.2 | 6.2 |
| coefficient [×10⁻⁵ | | | | | |
| (1/° C.)] | | | | | |
| | Examples | | | | |
| | 11A | 12A | 13A | 14A | 15A |
| Component A | | | | | |
| Rubber-reinforced | 97.5 | 97.5 | 97.5 | 97.5 | 97.5 |
| aromatic vinyl-based | | | | | |
| resin (part) | | | | | |
| Component B | | | | | |
| Ultrahigh molecular | 2.5 | 2.5 | 2.5 | 2.5 | 2.5 |
| weight aromatic vinyl- | | | | | |
| based resin (part) | | | | | |
| Component C | | | | | |
| Polyolefin wax (part) | 0.8 | — | — | — | — |
| Fatty acid metal salt | 1.7 | 3.0 | 5.8 | 5.8 | 5.8 |
| (part) | | | | | |
| Fatty acid amide | — | 0.8 | 1.7 | 1.7 | 1.7 |
| (part) | | | | | |
| Component D | | | | | |
| Wollastonite (part) | 66.7 | 66.7 | 66.7 | 66.7 | 66.7 |
| Talc (part) | — | — | — | — | — |
| Glass fibers (part) | — | — | — | — | — |
| Component E | | | | | |
| Vinyl chloride resin | 400 | 400 | 400 | 167 | 667 |
| (part) | | | | | |
| (Component D/component | 16.7 | 16.7 | 16.7 | 39.9 | 10.0 |
| E) × 100 (mass %) | | | | | |
| Surface appearance | B | B | A | A | A |
| (white streaks) | | | | | |
| Shape stability of | A | A | A | A | A |
| profile extrusion | | | | | |
| resin molded product | | | | | |
| Linear expansion | 6.2 | 6.3 | 6.2 | 6.0 | 6.9 |
| coefficient [×10⁻⁵ | | | | | |
| (1/° C.)] | | | | | |

TABLE 3

| | Examples | | | | | |
|---|---|---|---|---|---|---|
| | 16A | 17A | 18A | 19A | 20A | 21A |
| Component A | | | | | | |
| Rubber-reinforced | 97.5 | 97.5 | 97.5 | 97.5 | 97.5 | 96.5 |
| aromatic vinyl-based | | | | | | |
| resin (part) | | | | | | |
| Component B | | | | | | |
| Ultrahigh molecular | 2.5 | 2.5 | 2.5 | 2.5 | 2.5 | 3.5 |
| weight aromatic | | | | | | |
| vinyl-based resin | | | | | | |
| (part) | | | | | | |
| Component C | | | | | | |
| Polyolefin wax | — | — | 5.0 | — | — | — |
| (part) | | | | | | |
| Fatty acid metal | 5.8 | 8.3 | 3.3 | 5.8 | 5.8 | 5.8 |
| salt (part) | | | | | | |
| Fatty acid amide | 1.7 | 3.3 | 3.3 | 1.7 | 1.7 | 1.7 |
| (part) | | | | | | |
| Component D | | | | | | |
| Wollastonite (part) | 25.0 | 66.7 | 66.7 | — | — | 66.7 |
| Talc (part) | — | — | — | 66.7 | — | — |
| Glass fibers (part) | — | — | — | — | 66.7 | — |
| Component E | | | | | | |
| Vinyl chloride resin | 290 | 400 | 400 | 400 | 400 | 400 |
| (part) | | | | | | |
| (Component | 8.6 | 16.7 | 16.7 | 16.7 | 16.7 | 16.7 |
| D/component E) × 100 | | | | | | |
| (mass %) | | | | | | |
| Surface appearance | A | A | A | A | A | A |
| (white streaks) | | | | | | |
| Shape stability of | A | B | B | A | A | A |
| profile extrusion | | | | | | |
| resin molded product | | | | | | |
| Linear expansion | 7.1 | 6.2 | 6.3 | 6.5 | 5.3 | 6.2 |
| coefficient [×10⁻⁵ | | | | | | |
| (1/° C.)] | | | | | | |

| | Comparative Examples | | |
|---|---|---|---|
| | 3A | 4A | 5A |
| Component A | | | |
| Rubber-reinforced | 97.5 | 97.5 | 100 |
| aromatic vinyl-based | | | |
| resin (part) | | | |
| Component B | | | |
| Ultrahigh molecular | 2.5 | 2.5 | — |
| weight aromatic | | | |
| vinyl-based resin | | | |
| (part) | | | |
| Component C | | | |
| Polyolefin wax | — | — | — |
| (part) | | | |
| Fatty acid metal | — | 12.0 | 8.3 |
| salt (part) | | | |
| Fatty acid amide | — | 12.0 | — |
| (part) | | | |
| Component D | | | |
| Wollastonite (part) | 66.7 | 66.7 | 66.7 |
| Talc (part) | — | — | — |
| Glass fibers (part) | — | — | — |
| Component E | | | |
| Vinyl chloride resin | 400 | 400 | 400 |
| (part) | | | |
| (Component | 16.7 | 16.7 | 16.7 |
| D/component E) × 100 | | | |
| (mass %) | | | |
| Surface appearance | C | * | A |
| (white streaks) | | | |
| Shape stability of | A | * | C |
| profile extrusion | | | |
| resin molded product | | | |
| Linear expansion | 6.2 | * | 6.2 |
| coefficient [×10⁻⁵ | | | |
| (1/° C.)] | | | |

Note
*: Difficult to knead, and therefore subsequent evaluation was not possible.

From the results of Examples 1A to 5A and Comparative Examples 1A and 2A as shown in Table 1, the followings are apparently confirmed. That is, in Comparative Example 1A in which no lubricant (C) was used, the extrusion-molded sheet was deteriorated in scratch resistance, and the resulting profile extrusion resin molded product was deteriorated in surface appearance. In Comparative Example 2A in which no ultrahigh molecular weight aromatic vinyl-based resin (B) was used, the resulting product was deteriorated in drawdown property.

Further, from the results of Examples 6A to 21A and Comparative Examples 3A to 5A as shown in Tables 2 and 3, the followings are apparently confirmed. That is, in Comparative Example 3A in which no lubricant (C) was used, the resulting profile extrusion resin molded product was deteriorated in surface appearance. In Comparative Example 4A in which the lubricant (C) was used in an amount exceeding such a range as defined in the present invention, it was difficult to produce the master batch, and therefore, the subsequent evaluation was not possible. In Comparative Example 5A in which no ultrahigh molecular weight aromatic vinyl-based resin (B) was used, the resulting product was deteriorated in shape stability.

### <Profile Extrusion Molding Resin Composition According to Embodiment 2 of the Present Invention>

### Examples 1B to 8B and Comparative Examples 1B and 2B

The respective components as shown in Table 4 were kneaded and pelletized in the same manner as defined in Example 1A to thereby prepare a test piece to be evaluated. The thus prepared test piece was evaluated for various properties thereof by the above evaluation methods. The evaluation results are shown in Table 4. Also, the above pellets were extruded using a 25 mm sheet extruder equipped with a T-die (manufactured by Union Plastic Public Co., Ltd.) at an extrusion temperature of 220° C. and a screw rotating speed of 20 rpm to thereby prepare an extrusion-molded sheet.

TABLE 4

| | Examples | | | | |
|---|---|---|---|---|---|
| | 1B | 2B | 3B | 4B | 5B |
| Component A1 | | | | | |
| ABS resin (part) | 96.5 | 96.5 | 95.5 | — | — |
| ASA resin (part) | — | — | — | 96.5 | 96.5 |
| Component A2 | | | | | |
| AES resin (part) | 1.0 | 1.0 | 2.0 | 1.0 | 1.0 |
| Component B | | | | | |
| Ultrahigh | 2.5 | 2.5 | 2.5 | 2.5 | 2.5 |
| molecular weight | | | | | |
| AS resin (part) | | | | | |
| Component C | | | | | |
| Polyolefin wax | 0.5 | 1.0 | 2.0 | 0.5 | 1.0 |
| (part) | | | | | |
| Fatty acid ester | — | — | — | — | — |
| (part) | | | | | |
| Component D | | | | | |
| Wollastonite | 66.7 | 66.7 | 66.7 | 66.7 | 66.7 |
| (part) | | | | | |
| Scratch resistance | A | A | A | A | A |
| Kneading property | A | A | A | A | A |
| Tensile strength | 38 | 38 | 37 | 38 | 38 |
| (MPa) | | | | | |
| Flexural strength | 65 | 63 | 63 | 65 | 63 |
| (MPa) | | | | | |
| Flexural modulus | 6430 | 6400 | 6430 | 6430 | 6400 |
| (MPa) | | | | | |
| Charpy impact | 8 | 8 | 8 | 4 | 4 |
| strength (KJ/m²) | | | | | |
| Deflection | 87 | 85 | 85 | 87 | 85 |
| temperature under | | | | | |
| load (° C.) | | | | | |

| | Examples | | | Comparative Examples | |
|---|---|---|---|---|---|
| | 6B | 7B | 8B | 1B | 2B |
| Component A1 | | | | | |
| ABS resin (part) | — | — | 96.5 | — | — |
| ASA resin (part) | 95.5 | 94.5 | — | 97.5 | 94.5 |
| Component A2 | | | | | |
| AES resin (part) | 2.0 | 3.0 | 1.0 | — | 3.0 |
| Component B | | | | | |
| Ultrahigh | 2.5 | 2.5 | 2.5 | 2.5 | 2.5 |
| molecular weight | | | | | |
| AS resin (part) | | | | | |
| Component C | | | | | |
| Polyolefin wax | 2.0 | 3.0 | — | 3.0 | — |
| (part) | | | | | |
| Fatty acid ester | — | — | 1.0 | — | — |
| (part) | | | | | |
| Component D | | | | | |
| Wollastonite | 66.7 | 66.7 | 66.7 | 66.7 | 66.7 |
| (part) | | | | | |
| Scratch resistance | A | A | A | A | C |
| Kneading property | A | A | A | C | A |
| Tensile strength | 37 | 37 | 38 | 37 | 38 |
| (MPa) | | | | | |
| Flexural strength | 63 | 63 | 61 | 63 | 66 |
| (MPa) | | | | | |
| Flexural modulus | 6430 | 6430 | 6240 | 6430 | 6450 |
| (MPa) | | | | | |
| Charpy impact | 4 | 4 | 7 | 4 | 4 |
| strength (KJ/m²) | | | | | |
| Deflection | 85 | 84 | 82 | 84 | 87 |
| temperature under | | | | | |
| load (° C.) | | | | | |

### Examples 9B to 11B

In Example 9B, the above resin composition (pellets) obtained in Example 1B as shown in Table 4 was used as a master batch and then blended with a vinyl chloride resin in the form of pellets in such an amount as shown in Table 5. Then, the thus obtained blended material was charged into an extrusion molding machine to thereby produce a profile extrusion resin molded product having an concave sectional shape and a size of 50 mm in width×10 mm in height×2 mm in thickness. The above profile extrusion molding process was carried out in the same manner as defined in Example 1A. In Example 10B, the above resin composition (pellets) obtained in Example 3B as shown in Table 4 was used as a master batch, whereas in Example 11B, the above resin composition (pellets) obtained in Example 4B was used as a master batch. The respective resin compositions were blended with a vinyl chloride resin in the form of pellets in such an amount as shown in Table 5. Then, the thus obtained blended material was molded in the same manner as described above to thereby produce a profile extrusion resin molded product. The evaluation results of the molded products obtained in the respective Examples are shown in Table 5.

### Examples 12B to 22B

The respective components shown in Tables 5 and 6 were kneaded by the following procedures (i) and (ii).

(i) First, the respective components except for the component (D) as shown in Tables 5 and 6 (but except for the vinyl chloride resin) were mixed with each other using a Henschel mixer, and then melted and kneaded using a twin-screw extruder “TEX44αII” manufactured by The Japan Steel Works, Ltd. The respective components except for the component (D) were charged into the extruder through a weight feeder from one end thereof. In addition, the component (D) was charged into the extruder from a mid portion thereof.
(ii) Next, the thus obtained pellets were fully dried and used as a master batch, and then blended with a vinyl chloride resin in the form of pellets in such an amount as shown in Tables 5 and 6. Then, the thus obtained blended material was molded in the same manner as described in Examples 9B to 11B to thereby produce a profile extrusion resin molded product. The evaluation results of the molded products obtained in the respective Examples are shown in Tables 5 and 6.

### Comparative Examples 3B to 5B

In Comparative Example 3B, the above resin composition (pellets) obtained in Comparative Example 2B as shown in Table 4 was used as a master batch and then blended with a vinyl chloride resin in the form of pellets in such an amount as shown in Table 6. Then, the thus obtained blended material was molded in the same manner as described in Examples 9B to 11B to thereby produce a profile extrusion resin molded product. On the other hand, in Comparative Examples 4B and 5B, in the same manner as defined in Examples 12B to 22B, the respective components as shown in Table 6 (except for the vinyl chloride resin) were mixed with each other using a Henschel mixer, and then melted and kneaded using a twin-screw extruder “TEX44αII” manufactured by The Japan Steel Works, Ltd. The respective components except for the component (D) were charged into the extruder through a weight feeder from one end thereof. In addition, the component (D) was charged into the extruder from a mid portion thereof. Next, the thus obtained pellets were fully dried and used as a master batch, and then blended with a vinyl chloride resin in the form of pellets in such an amount as shown in Table 6. Then, the thus obtained blended material was molded in the same manner as described in Examples 9B and 11B to thereby produce a profile extrusion resin molded product. The evaluation results of the molded products obtained in the respective Comparative Examples are shown in Table 6.

TABLE 5

| | Examples | | | | |
|---|---|---|---|---|---|
| | 9B | 10B | 11B | 12B | 13B |
| Component A1 | | | | | |
| ABS resin (part) | 96.5 | 95.5 | — | 96.5 | 96.5 |
| ASA resin (part) | — | — | 96.5 | — | — |
| Component A2 | | | | | |
| AES resin (part) | 1.0 | 2.0 | 1.0 | 1.0 | 1.0 |
| Component B | | | | | |
| Ultrahigh molecular | 2.5 | 2.5 | 2.5 | 2.5 | 2.5 |
| weight AS resin (part) | | | | | |
| Component C | | | | | |
| Polyolefin wax (part) | 0.5 | 2.0 | 0.5 | — | — |
| Fatty acid metal salt | — | — | — | 8.3 | — |
| (part) | | | | | |
| Fatty acid amide | — | — | — | — | 8.3 |
| (part) | | | | | |
| Component D | | | | | |
| Wollastonite (part) | 66.7 | 66.7 | 66.7 | 66.7 | 66.7 |
| Talc (part) | — | — | — | — | — |
| Glass fibers (part) | — | — | — | — | — |
| Component E | | | | | |
| Vinyl chloride resin | 400 | 400 | 400 | 400 | 400 |
| (part) | | | | | |
| (Component D/component | 16.7 | 16.7 | 16.7 | 16.7 | 16.7 |
| E) × 100 (mass %) | | | | | |
| Surface appearance | B | B | B | A | A |
| (white streaks) | | | | | |
| Shape stability of | A | A | A | A | A |
| profile extrusion | | | | | |
| resin molded product | | | | | |
| Linear expansion | 6.2 | 6.2 | 6.2 | 6.2 | 6.3 |
| coefficient [×10⁻⁵ | | | | | |
| (1/° C.)] | | | | | |

| | Examples | | | |
|---|---|---|---|---|
| | 14B | 15B | 16B | 17B |
| Component A1 | | | | |
| ABS resin (part) | 96.5 | — | 96.5 | 96.5 |
| ASA resin (part) | — | 96.5 | — | — |
| Component A2 | | | | |
| AES resin (part) | 1.0 | 1.0 | 1.0 | 1.0 |
| Component B | | | | |
| Ultrahigh molecular | 2.5 | 2.5 | 2.5 | 2.5 |
| weight AS resin (part) | | | | |
| Component C | | | | |
| Polyolefin wax (part) | — | — | — | — |
| Fatty acid metal salt | 5.8 | 5.8 | 5.8 | 5.8 |
| (part) | | | | |
| Fatty acid amide | 1.7 | 1.7 | 1.7 | 1.7 |
| (part) | | | | |
| Component D | | | | |
| Wollastonite (part) | 66.7 | 66.7 | 66.7 | 66.7 |
| Talc (part) | — | — | — | — |
| Glass fibers (part) | — | — | — | — |
| Component E | | | | |
| Vinyl chloride resin | 400 | 400 | 167 | 667 |
| (part) | | | | |
| (Component D/component | 16.7 | 16.7 | 39.9 | 10.0 |
| E) × 100 (mass %) | | | | |
| Surface appearance | A | A | A | A |
| (white streaks) | | | | |
| Shape stability of | A | A | A | A |
| profile extrusion | | | | |
| resin molded product | | | | |
| Linear expansion | 6.3 | 6.2 | 6.0 | 6.9 |
| coefficient [×10⁻⁵ | | | | |
| (1/° C.)] | | | | |

TABLE 6

| | Examples | | | | |
|---|---|---|---|---|---|
| | 18B | 19B | 20B | 21B | 22B |
| Component A1 | | | | | |
| ABS resin (part) | 96.5 | 96.5 | 96.5 | 96.5 | 96.5 |
| ASA resin (part) | — | — | — | — | — |
| Component A2 | | | | | |
| AES resin (part) | 1.0 | 1.0 | 1.0 | 1.0 | 1.0 |
| Component B | | | | | |
| Ultrahigh molecular | 2.5 | 2.5 | 2.5 | 2.5 | 2.5 |
| weight AS resin (part) | | | | | |
| Component C | | | | | |
| Polyolefin wax (part) | — | — | 5.0 | — | — |
| Fatty acid metal salt | 5.8 | 8.3 | 3.3 | 5.8 | 5.8 |
| (part) | | | | | |
| Fatty acid amide | 1.7 | 3.3 | 3.3 | 1.7 | 1.7 |
| (part) | | | | | |
| Component D | | | | | |
| Wollastonite (part) | 25.0 | 66.7 | 66.7 | — | — |
| Talc (part) | — | — | — | 66.7 | — |
| Glass fibers (part) | — | — | — | — | 66.7 |
| Component E | | | | | |
| Vinyl chloride resin | 290 | 400 | 400 | 400 | 167 |
| (part) | | | | | |
| (Component D/component | 8.6 | 16.7 | 16.7 | 16.7 | 39.9 |
| E) × 100 (mass %) | | | | | |
| Surface appearance | A | A | A | A | A |
| (white streaks) | | | | | |
| Shape stability of | A | B | B | A | A |
| profile extrusion | | | | | |
| resin molded product | | | | | |
| Linear expansion | 7.1 | 6.2 | 6.3 | 6.5 | 5.3 |
| coefficient [×10⁻⁵ | | | | | |
| (1/° C.)] | | | | | |

| | Comparative Examples | | |
|---|---|---|---|
| | 3B | 4B | 5B |
| Component A1 | | | |
| ABS resin (part) | — | — | — |
| ASA resin (part) | 94.5 | 94.5 | 97.0 |
| Component A2 | | | |
| AES resin (part) | 3.0 | 3.0 | 3.0 |
| Component B | | | |
| Ultrahigh molecular | 2.5 | 2.5 | — |
| weight AS resin (part) | | | |
| Component C | | | |
| Polyolefin wax (part) | — | — | — |
| Fatty acid metal salt | — | 12.0 | 8.3 |
| (part) | | | |
| Fatty acid amide | — | 12.0 | — |
| (part) | | | |
| Component D | | | |
| Wollastonite (part) | 66.7 | 66.7 | 66.7 |
| Talc (part) | — | — | — |
| Glass fibers (part) | — | — | — |
| Component E | | | |
| Vinyl chloride resin | 400 | 400 | 400 |
| (part) | | | |
| (Component D/component | 16.7 | 16.7 | 16.7 |
| E) × 100 (mass %) | | | |
| Surface appearance | C | * | A |
| (white streaks) | | | |
| Shape stability of | A | * | C |
| profile extrusion | | | |
| resin molded product | | | |
| Linear expansion | 6.2 | * | 6.3 |
| coefficient [×10⁻⁵ | | | |
| (1/° C.)] | | | |

Note *:
Difficult to knead, and therefore subsequent evaluation was not possible.

From the results of Examples 1B to 8B and Comparative Examples 1B and 2B as shown in Table 4, the followings are apparently confirmed. That is, in Comparative Example 1B in which no ethylene-α-olefin-based rubber-reinforced aromatic vinyl-based resin (A2) was used, the resulting resin composition was deteriorated in kneading property. In Comparative Example 2B in which no lubricant (C) was used, the resulting molded product was deteriorated in scratch resistance.

Further, from the results of Examples 9B to 22B and Comparative Examples 3B to 5B as shown in Tables 5 and 6, the followings are apparently confirmed. That is, in Comparative Example 3B in which no lubricant (C) was used, the resulting profile extrusion resin molded product suffered from formation of white streaks and therefore was deteriorated in surface appearance. In Comparative Example 4B in which the lubricant (C) was used in an amount exceeding such a range as defined in the present invention, it was difficult to produce the master batch, and therefore the subsequent evaluation was not possible. In Comparative Example 5B in which no ultrahigh molecular weight aromatic vinyl-based resin (B) was used, the resulting profile extrusion resin molded product was deteriorated in shape stability.

1. A profile extrusion molding resin composition comprising an aromatic vinyl-based resin component which comprises 80 to 99.9% by mass of a rubber-reinforced aromatic vinyl-based resin (A) having the following definition (1) and 0.1 to 20% by mass of an ultrahigh molecular weight aromatic vinyl-based resin (B) having the following definition (2) (with the proviso that a total amount of the component (A) and the component (B) is 100% by mass), said resin composition further comprising a lubricant (C) and an inorganic filler (D) in amounts of 0.1 to 20 parts by mass and 10 to 100 parts by mass, respectively, based on 100 parts by mass of the aromatic vinyl-based resin component:
(1) A resin which is constituted from a graft polymer (a1) obtained by graft-polymerizing a monomer component comprising an aromatic vinyl compound in the presence of a rubber polymer and, if required, a polymer (a2) obtained by polymerizing a monomer component comprising an aromatic vinyl compound (with the proviso that a content of the component (a2) is not more than 90% by mass based on a total amount of the components (a1) and (a2)), and which has an acetone-soluble component having a weight-average molecular weight of not more than 1,000,000; and
(2) a resin which is obtained by polymerizing a monomer component comprising an aromatic vinyl compound, and which has an acetone-soluble component having a weight-average molecular weight of not less than 2,000,000.

2. A profile extrusion molding resin composition according to claim 1, wherein the rubber-reinforced aromatic vinyl-based resin (A) comprises 60 to 99.8% by mass of a rubber-reinforced aromatic vinyl-based resin (A1) having the following definition (1′) and 0.1 to 20% by mass of an ethylene-α-olefin-based rubber-reinforced aromatic vinyl-based resin (A2) having the following definition (2′):
(1′) A resin which is constituted from the graft polymer (a1) obtained by graft-polymerizing a monomer component comprising an aromatic vinyl compound in the presence of a rubber polymer (except for an ethylene-α-olefin-based rubber) and, if required, the polymer (a2) obtained by polymerizing a monomer component comprising an aromatic vinyl compound (with the proviso that a content of the component (a2) is not more than 90% by mass based on a total amount of the components (a1) and (a2)), and which has an acetone-soluble component having a weight-average molecular weight of not more than 1,000,000; and
(2′) a resin which is constituted from a graft polymer (b1) obtained by graft-polymerizing a monomer component comprising an aromatic vinyl compound in the presence of an ethylene-α-olefin-based rubber and, if required, a polymer (b2) obtained by polymerizing a monomer component comprising an aromatic vinyl compound (with the proviso that a content of the component (b2) is not more than 90% by mass based on a total amount of the components (a1) and (a2)), and which has an acetone-soluble component having a weight-average molecular weight of not more than 1,000,000.

3. A profile extrusion molding resin composition according to claim 1, wherein the rubber polymer in the rubber-reinforced aromatic vinyl-based resin (A) is a diene-based rubber polymer.

4. A profile extrusion molding resin composition according to claim 2, wherein the rubber polymer in the rubber-reinforced aromatic vinyl-based resin (A1) is an acryl-based rubber polymer and/or a diene-based rubber polymer.

5. A profile extrusion molding resin composition according to claim 1, wherein the monomer component comprising an aromatic vinyl compound in the ultrahigh molecular weight aromatic vinyl-based resin (B) is a monomer component comprising an aromatic vinyl compound and a cyanided vinyl compound.

6. A profile extrusion molding resin composition according to claim 1, wherein the lubricant (C) is a polyolefin wax.

7. A profile extrusion molding resin composition according to claim 1, wherein the lubricant (C) is a polyethylene wax.

8. A profile extrusion molding resin composition according to claim 1, wherein the inorganic filler (D) is wollastonite.

9. A profile extrusion molding resin composition according to claim 1, further comprising a vinyl chloride-based resin (E), wherein a content of the inorganic filler (D) in the resin composition is 3 to 80 parts by mass based on 100 parts by mass of the vinyl chloride-based resin.

10. A profile extrusion resin molded product comprising the profile extrusion molding resin composition as defined in claim 1.
